(19) United States
(12) Patent Application Publication
(10) Pub. No.: US 2010/0093242 A1
(43) Pub. Date: Apr. 15, 2010

(54) Composite Article Having Excellent Fire Resistance

(76) Inventors: Dimitris Elias Katsoulis, Midland, MI (US); Widland Robert O'Brien, Midland, MI (US); Aaron Seitz, Midland, MI (US); Bizhong Zhu, Midland, MI (US)

Correspondence Address: HOWARD & HOWARD ATTORNEYS PLLC, 450 West Fourth Street, Royal Oak, MI, 48067, US

(21) Appl. No.: 12/527,873

(22) PCT Filed: Feb. 21, 2008
(86) PCT No.: PCT/US08/02287

§ 371 Date: Aug. 20, 2009

(30) Foreign Application Priority Data
Feb. 22, 2007 (US) 60891165
Feb. 21, 2008 (US) PCT/US2008/002287

(51) Int. Cl. B32B 27/08; B32B 9/04; D03D 25/00; D04H 13/00

(52) U.S. Cl. 442/181; 428/447; 442/327

(57) ABSTRACT

A composite article includes a first window layer formed from a vitreous material and a reinforced silicone layer disposed adjacent the first window layer. The reinforced silicone layer includes a cured silicone composition and a fiber reinforcement. Due to the presence of the cured silicone composition in the reinforced silicone layer, the composite article exhibits excellent fire resistance and will not emit as much smoke and toxic gases as composite articles including primarily carbon-based materials. Further, due to the presence of the fiber reinforcement in the reinforced silicone layer, the composite article maintains excellent structural integrity even after a breach is formed in the composite article due to heat. As such, the composite articles of the subject invention may be suitable for load-bearing applications that are not possible with existing composite articles.

### RELATED APPLICATIONS

This patent application claims priority to and all advantages of U.S. Provisional Patent Application No. 60/891,165 which was filed on Feb. 22, 2007.

### BACKGROUND OF THE INVENTION

1. Field of the Invention

The present invention generally relates to a composite article that has excellent fire resistance. More specifically, the present invention relates to a composite article having a window layer and a novel silicone layer that provides the excellent fire resistance to the composite article.

2. Description of the Prior Art

Fire-proof windows are known for use in the residential, commercial, and industrial construction industries, as well as the consumer appliance and automotive industries, for preventing fire, smoke, or extreme heat from propagating through buildings or to contain heat or fire within a space, such as in an oven. The fire-proof windows are typically rated as either 30, 60, or 90 minute fire-proof windows, depending on how long it takes to form a breach in the fire-proof windows when the fire-proof windows are exposed to a predefined fire condition leading to an exposure temperature of 843° C. after 30 minutes, 926° C. after 60 minutes, 1010° C. after 120 minutes, and 1093° C. after 240 minutes from startup. For example, a breach forms in a 30 minute rated fire-proof window when the window is exposed to the above predefined fire condition for a period of over 30 minutes, but less than 60 minutes. The specific fire-proof rating required of the fire-proof windows depends upon the application and cost considerations, since fire-proof windows with longer fire-proof ratings are typically more costly than fire-proof windows having shorter fire-proof ratings.

Much work has been done to develop fire-proof windows that have sufficient fire-proof ratings. The fire-proof windows are typically formed from a series of layers, including conventional glass layers and a layer that provides the fire resistance to the fire-proof windows. Many different materials have been used to form the layer that provides the fire resistance; however, many of the materials used to form the layer that provides the fire resistance have shortcomings. For example, when carbon-based materials, especially primarily carbon-based materials having more than 50 parts by weight carbon, based on the total weight of all molecules in the material, are used to form the layer that provides the fire resistance, the materials will eventually emit excessive amounts of smoke and toxic gases.

Other non-carbon based materials that will not emit as much smoke and toxic gases, as compared to when primarily carbon-based materials are used, have also been used for the layer that provides the fire resistance. For example, inorganic silicon-based materials have been used in the layer that provides the fire resistance in the fire-proof windows. Specific examples of inorganic silicon-based materials that have been used to form the layer that provides fire resistance in the fire-proof windows include alkali metal polysilicate hydrate, as disclosed in U.S. Pat. No. 6,159,606 to Gelderie et al., a composition obtained through hydrolysis and condensation of silicates, as disclosed in U.S. Pat. No. 5,716,424 to Mennig et al., and a silicone elastomer, as disclosed in German Patent Application No. 2826261. Although the inorganic silicon-based materials will char, the inorganic silicon-based materials produce less smoke and toxic gas, as compared to primarily carbon-based materials. However, fire-proof windows including layers formed from the silicone-based materials are extremely labor intensive to fabricate, heavy, and sometimes insufficiently able to maintain structural integrity upon failure under heat. More specifically, once the breach forms in the fire-proof windows due to heat, the fire-proof windows are prone to mechanical failure.

Due to the deficiencies of the existing fire-proof windows, it would be advantageous to provide a composite article having excellent fire resistance that is substantially more cost effective to fabricate, is lighter in weight, and also maintains excellent structural integrity even after failure of the composite article under heat, i.e., after a breach forms in the composite article, and that also will not emit as much smoke and toxic gases as composite articles including primarily carbon-based materials.

### SUMMARY OF THE INVENTION AND ADVANTAGES

The subject invention provides a composite article comprising a first window layer formed from a vitreous material and a reinforced silicone layer disposed adjacent the first window layer. The reinforced silicone layer includes a cured silicone composition and a fiber reinforcement. Due to the presence of the cured silicone composition in the reinforced silicone layer, the composite article exhibits excellent fire resistance and will not emit as much smoke and toxic gases as composite articles including primarily carbon-based materials. Further, due to the presence of the fiber reinforcement in the reinforced silicone layer, the composite article maintains excellent structural integrity even after a breach is formed in the composite article due to heat. As such, the composite articles of the subject invention may be suitable for load-bearing applications that are not possible with the composite articles of the prior art.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional side view of a composite article of the present invention;

FIG. 2 is a cross-sectional side view of another embodiment of the composite article of the present invention;

FIG. 3 is a cross-sectional side view of another embodiment of the composite article of the present invention

FIG. 4 is a chart showing a temperature of a cold side of the composite article during heating; and

FIG. 5 is a chart showing a rate of heating of a furnace that correlates to the temperature of the cold side of the composite article as illustrated in the chart of FIG. 4.

### DETAILED DESCRIPTION OF THE INVENTION

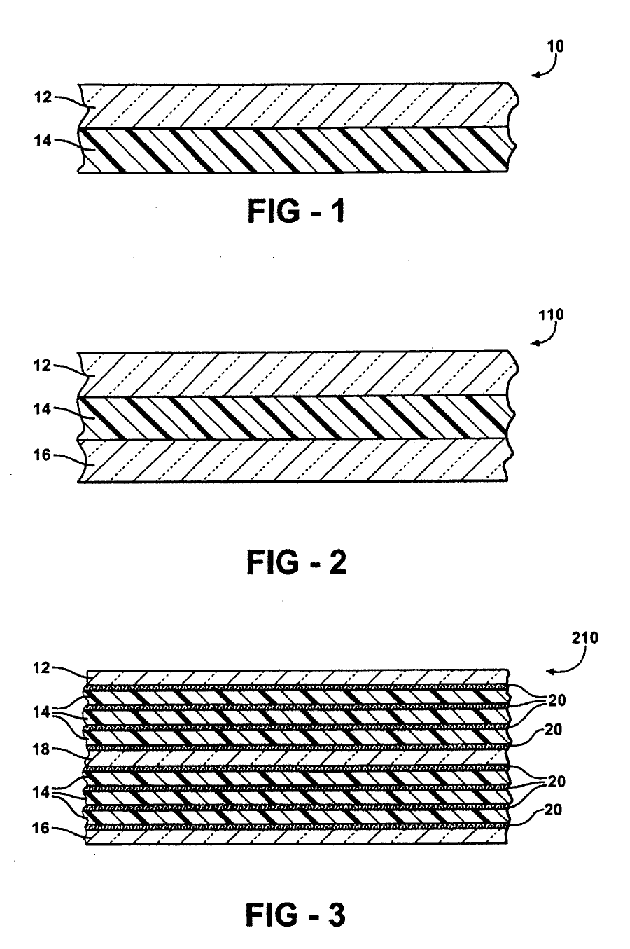

Referring to the Figures, wherein like numerals indicate corresponding parts throughout the several views, a composite article is shown generally at 10 in FIG. 1. The composite article 10 has excellent fire resistance and is useful in the residential, commercial, and industrial construction industries, as well as the consumer appliance and automotive industries, for preventing fire, smoke, or extreme heat from propagating through buildings or to contain heat or fire within a space, such as in an oven. The composite article 10 of the present invention may also be suitable for load-bearing applications, as will be appreciated with reference to the further description of the composite article 10 below.

The composite article 10 includes a first window layer 12 that is formed from a vitreous material. The first window layer 12 typically has high transparency of at least 80%; however, it is to be appreciated that window layers having less than 80% transparency may also be suitable for purposes of the present invention. The first window layer 12 provides wear and scratch-resistance that is typical of conventional windows.

The vitreous material that forms the first window layer 12 is further defined as any material that is commonly used to form windows. Specific examples of suitable vitreous materials that may be used to form the first window layer 12 include common silica-based glass or a carbon-based polymer. One specific example of a common silica-based glass is soda-lime-silica glass. Specific examples of carbon-based polymers that are suitable for forming the first window layer 12 include, but are not limited to, polymethyl methacrylate (PMMA), polycarbonate, and acrylic.

The first window layer 12 may be formed through any method as known in the art for forming window layers. Typically, the first window layer 12 is float glass, which is formed through a float process; however, the glass may be tempered glass, plate glass, etc., which are formed through methods that are known in the art for forming those types of glass. It is to be appreciated that any type of glass formed through any known process is suitable for purposes of the present invention.

The first window layer 12 typically has a thickness of from about 0.002 to about 1 inch, typically about 0.125 inch. The specific thickness of the first window layer 12 is dependent on the specific application for which the composite article 10 is intended. For example, for load bearing applications or applications in which the composite article 10 can preferably withstand significant blunt force, the first window layer 12 may have a greater thickness than it would for decorative applications. However, it is to be appreciated that the composite article of the present invention is not limited to use in load bearing applications.

The composite article 10 of the present invention further comprises a reinforced silicone layer 14. The reinforced silicone layer 14 provides the excellent fire resistance to the composite article 10, as described in further detail below. The reinforced silicone layer 14 comprises a cured silicone composition and a fiber reinforcement. Typically, the fiber reinforcement is impregnated with the cured silicone composition, i.e., the reinforced silicone layer 14 is a single layer including the fiber reinforcement and the cured silicone composition. The reinforced silicone layer 14 typically has less than 50 parts by weight carbon, more typically less than 35 parts by weight carbon, based on the total weight of the reinforced silicone layer 14 in order to ensure that the reinforced silicone layer 14 will emit sufficiently low levels of smoke and toxic gases during burning.

In one embodiment, the cured silicone composition is further defined as a hydrosilylation-cured silicone composition. The hydrosilylation-cured silicone composition comprises the reaction product of (A) a silicone resin and (B) an organosilicon compound having an average of at least two silicon-bonded hydrogen atoms per molecule in an amount sufficient to cure the silicone resin, in the presence of (C) a catalytic amount of a hydrosilylation catalyst. Any hydrosilylation-cured silicone compositions that are known in the art may be suitable for purposes of the present invention; however, some hydrosilylation-cured silicone compositions are more suitable than others. More specifically, some silicone resins (A) are more suitable than others.

The silicone resin (A) typically has silicon-bonded alkenyl groups or silicon-bonded hydrogen atoms. The silicone resin (A) is typically a copolymer including R²SiO_{3/2} units, i.e., T units, and/or SiO_{4/2} units, i.e., Q units, in combination with R¹R²₂SiO_{1/2} units, i.e., M units, and/or R²₂SiO_{2/2} units, i.e., D units, wherein R¹ is a C₁ to C₁₀ hydrocarbyl group or a C₁ to C₁₀ halogen-substituted hydrocarbyl group, both free of aliphatic unsaturation, and R² is R¹, an alkenyl group, or hydrogen. For example, the silicone resin can be a DT resin, an MT resin, an MDT resin, a DTQ resin, and MTQ resin, and MDTQ resin, a DQ resin, an MQ resin, a DTQ resin, an MTQ resin, or an MDQ resin. As used herein, the term “free of aliphatic unsaturation” means the hydrocarbyl or halogen-substituted hydrocarbyl group does not contain an aliphatic carbon-carbon double bond or carbon-carbon triple bond.

The C₁ to C₁₀ hydrocarbyl group and C₁ to C₁₀ halogen-substituted hydrocarbyl group represented by R¹ more typically have from 1 to 6 carbon atoms. Acyclic hydrocarbyl and halogen-substituted hydrocarbyl groups containing at least 3 carbon atoms can have a branched or unbranched structure. Examples of hydrocarbyl groups represented by R¹ include, but are not limited to, alkyl groups, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl groups, such as cyclopentyl, cyclohexyl, and methylcyclohexyl; aryl groups, such as phenyl and naphthyl; alkaryl groups, such as tolyl and xylyl; and aralkyl groups, such as benzyl and phenethyl. Examples of halogen-substituted hydrocarbyl groups represented by R¹ include, but are not limited to, 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

The alkenyl groups represented by R², which may be the same or different within the silicone resin, typically have from 2 to about 10 carbon atoms, alternatively from 2 to 6 carbon atoms, and are exemplified by, but not limited to, vinyl, allyl, butenyl, hexenyl, and octenyl. In one embodiment, R² is predominantly the alkenyl group. In this embodiment, typically at least 50 mol %, alternatively at least 65 mol %, alternatively at least 80 mol %, of the groups represented by R² in the silicone resin are alkenyl groups. As used herein, the mol % of alkenyl groups in R² is defined as a ratio of the number of moles of silicon-bonded alkenyl groups in the silicone resin to the total number of moles of the R² groups in the resin, multiplied by 100. In another embodiment, R² is predominantly hydrogen. In this embodiment, typically at least 50 mol %, alternatively at least 65 mol %, alternatively at least 80 mol %, of the groups represented by R² in the silicone resin are hydrogen. The mol % of hydrogen in R² is defined as a ratio of the number of moles of silicon-bonded hydrogen in the silicone resin to the total number of moles of the R² groups in the resin, multiplied by 100.

According to a first embodiment, the silicone resin (A) has the formula:

(R¹R²₂SiO_{1/2})_{w}(R²₂SiO_{2/2})ₓ(R²SiO_{3/2})_{y}(SiO_{4/2})_{z} (I)

wherein R¹ and R² are as described and exemplified above, w, x, y, and z are mole fractions. The silicone resin represented by formula (I) has an average of at least two silicon-bonded alkenyl groups per molecule. More specifically, the subscript w typically has a value of from 0 to 0.9, alternatively from 0.02 to 0.75, alternatively from 0.05 to 0.3. The subscript x typically has a value of from 0 to 0.9, alternatively from 0 to 0.45, alternatively from 0 to 0.25. The subscript y typically has a value of from 0 to 0.99, alternatively from 0.25 to 0.8, alternatively from 0.5 to 0.8. The subscript z typically has a value of from 0 to 0.85, alternatively from 0 to 0.25, alternatively from 0 to 0.15. Also, the ratio y+z/(w+x+y+z) is typically from 0.1 to 0.99, alternatively from 0.5 to 0.95, alternatively from 0.65 to 0.9. Further, the ratio w+x/(w+x+y+z) is typically from 0.01 to 0.90, alternatively from 0.05 to 0.5, alternatively from 0.1 to 0.35.

When R² is predominantly the alkenyl group, specific examples of silicone resins represented by formula (I) above include, but are not limited to, resins having the following formulae:

(Vi₂MeSiO_{1/2})_{0.25}(PhSiO_{3/2})_{0.75},

(ViMe₂SiO_{1/2})_{0.25}(PhSiO_{3/2})_{0.75},

(ViMe₂SiO_{1/2})_{0.25}(MeSiO_{3/2})_{0.25}(PhSiO_{3/2})_{0.50},

(ViMe₂SiO_{1/2})_{0.15}(PhSiO_{3/2})_{0.75}(SiO_{4/2})_{0.1},

and

(Vi₂MeSiO_{1/2})_{0.15}(ViMe₂SiO_{1/2})_{0.1}(PhSiO_{3/2})_{0.75},

wherein Me is methyl, Vi is vinyl, Ph is phenyl, and the numerical subscripts outside the parenthesis denote mole fractions corresponding to either w, x, y, or z as described above for formula (I). The sequence of units in the preceding formulae is not to be viewed in any way as limiting to the scope of the invention.

When R² is predominantly hydrogen, specific examples of silicone resins represented by formula (I) above include, but are not limited to, resins having the following formulae:

(HMe₂SiO_{1/2})_{0.25}(PhSiO_{3/2})_{0.75},

(HMeSiO_{2/2})_{0.3}(PhSiO_{3/2})_{0.6}(MeSiO_{3/2})_{0.1},

and

(Me₃SiO_{1/2})_{0.1}(H₂SiO_{2/2})_{0.1}(MeSiO_{3/2})_{0.4}(PhSiO_{3/2})_{0.4},

wherein Me is methyl, Ph is phenyl, and the numerical subscripts outside the parenthesis denote mole fractions. The sequence of units in the preceding formulae is not to be viewed in any way as limiting to the scope of the invention.

The silicone resin represented by formula (I) typically has a number-average molecular weight (Mₙ) of from 500 to 50,000, alternatively from 500 to 10,000, alternatively 1,000 to 3,000, where the molecular weight is determined by gel permeation chromatography employing a low angle laser light scattering detector, or a refractive index detector and silicone resin (MQ) standards.

The viscosity of the silicone resin represented by formula (I) at 25° C. is typically from 0.01 to 100,000 Pa·s, alternatively from 0.1 to 10,000 Pa·s, alternatively from 1 to 100 Pa·s.

The silicone resin represented by formula (I) typically includes less than 10% (w/w), alternatively less than 5% (w/w), alternatively less than 2% (w/w), of silicon-bonded hydroxy groups, as determined by ²⁹Si NMR.

Methods of preparing silicone resins represented by formula (I) are well known in the art; many of these resins are commercially available. Silicone resins represented by formula (I) are typically prepared by cohydrolyzing the appropriate mixture of chlorosilane precursors in an organic solvent, such as toluene. For example, a silicone resin including R¹R²₂SiO_{1/2} units and R²SiO_{3/2} units can be prepared by cohydrolyzing a first compound having the formula R¹R²₂SiCl and a second compound having the formula R²SiCl₃ in toluene, where R¹ and R² are as defined and exemplified above, to form aqueous hydrochloric acid and the silicone resin, which is a hydrolyzate of the first and second compounds. The aqueous hydrochloric acid and the silicone resin are separated, the silicone resin is washed with water to remove residual acid, and the silicone resin is heated in the presence of a mild condensation catalyst to “body” the silicone resin to a desired viscosity, as known in the art.

If desired, the silicone resin can be further treated with a condensation catalyst in an organic solvent to reduce the content of silicon-bonded hydroxy groups. Alternatively, first or second compounds containing hydrolysable groups other than chloro, such —Br, —I, —OCH₃, —OC(O)CH₃, —N(CH₃)₂, NHCOCH₃, and —SCH₃, can be cohydrolyzed to form the silicone resin. The properties of the silicone resin depend on the types of first and second compounds, the mole ratio of first and second compounds, the degree of condensation, and the processing conditions.

The organosilicon compound (B) has an average of at least two silicon-bonded hydrogen atoms per molecule, alternatively at least three silicon-bonded hydrogen atoms per molecule. It is generally understood that cross-linking occurs when the sum of the average number of alkenyl groups per molecule in the silicone resin (A) and the average number of silicon-bonded hydrogen atoms per molecule in the organosilicon compound (B) is greater than four, and each molecule has two or more reactive groups. Prior to curing, the organosilicon compound (B) is present in an amount sufficient to cure the silicone resin (A).

The organosilicon compound (B) may be further defined as an organohydrogensilane, an organohydrogensiloxane, or a combination thereof. The structure of the organosilicon compound (B) can be linear, branched, cyclic, or resinous. In acyclic polysilanes and polysiloxanes, the silicon-bonded hydrogen atoms can be located at terminal, pendant, or at both terminal and pendant positions. Cyclosilanes and cyclosiloxanes typically have from 3 to 12 silicon atoms, alternatively from 3 to 10 silicon atoms, alternatively from 3 to 4 silicon atoms.

The organohydrogensilane can be a monosilane, disilane, trisilane, or polysilane. When R² is predominantly the alkenyl group, specific examples of organohydrogensilanes that are suitable for purposes of the present invention include, but are not limited to, diphenylsilane, 2-chloroethylsilane, bis[(p-dimethylsilyl)phenyl]ether, 1,4-dimethyldisilylethane, 1,3,5-tris(dimethylsilyl)benzene, 1,3,5-trimethyl-1,3,5-trisilane, poly(methylsilylene)phenylene, and poly(methylsilylene)methylene. When R² is predominantly hydrogen, specific examples of organohydrogensilanes that are suitable for purposes of the present invention include, but are not limited to, silanes having the following formulae:

Pr₂SiH₂,

PhSiH₃,

MeSiH₃,

PhMeSiH₂,

Ph₂SiH₂,

and

(HMeSiO)₄,

wherein Pr is propyl, Me is methyl, and Ph is phenyl.

The organohydrogensilane can also have the formula:

HR¹₂Si—R³—SiR¹₂H (II)

wherein R¹ is as defined and exemplified above and R³ is a hydrocarbylene group free of aliphatic unsaturation having a formula selected from the following structures:

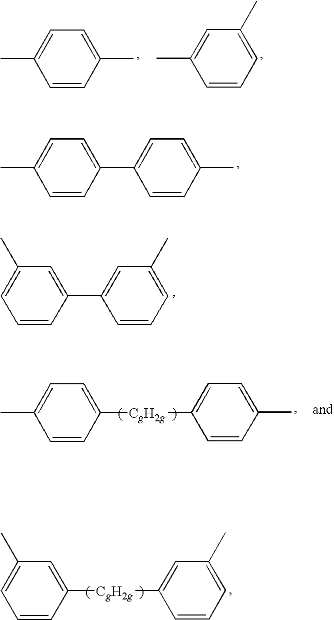

wherein g is from 1 to 6.

Specific examples of organohydrogensilanes having the formula (II), wherein R¹ and R³ are as described and exemplified above include, but are not limited to, organohydrogensilanes having a formula selected from the following structures:

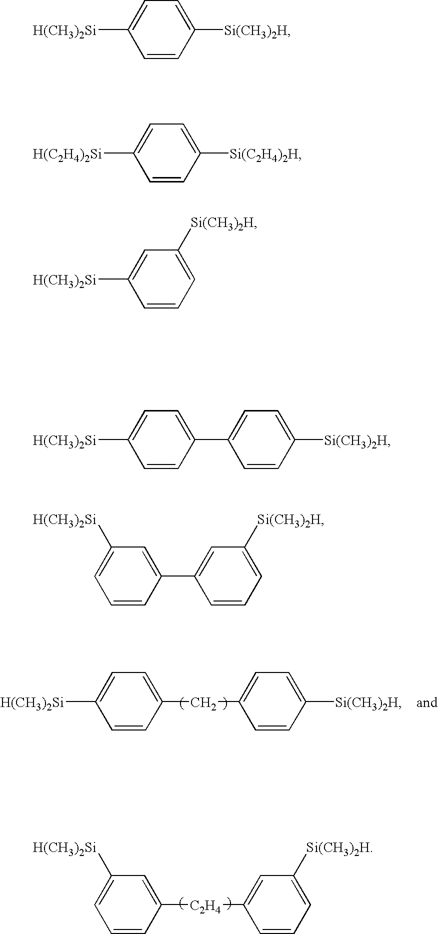

Methods of preparing the organohydrogensilanes are known in the art. For example, organohydrogensilanes can be prepared by reaction of Grignard reagents with alkyl or aryl halides. In particular, organohydrogensilanes having the formula HR¹₂Si—R³—SiR¹₂H can be prepared by treating an aryl dihalide having the formula R³X₂ with magnesium in ether to produce the corresponding Grignard reagent and then treating the Grignard reagent with a chlorosilane having the formula HR¹₂SiCl, where R¹ and R³ are as described and exemplified above.

The organohydrogensiloxane can be a disiloxane, trisiloxane, or polysiloxane. Examples of organosiloxanes suitable for use as the organosilicon compound (B) when R² is predominantly hydrogen include, but are not limited to, siloxanes having the following formulae:

PhSi(OSiMe₂H)₃,

Si(OSiMe₂H)₄,

MeSi(OSiMe₂H)₃,

and

Ph₂Si(OSiMe₂H)₂,

wherein Me is methyl, and Ph is phenyl.

Specific examples of organohydrogensiloxanes that are suitable for purposes of the present invention when R² is predominantly alkenyl group including, but are not limited to, 1,1,3,3-tetramethyldisiloxane, 1,1,3,3-tetraphenyldisiloxane, phenyltris(dimethylsiloxy)silane, 1,3,5-trimethylcyclotrisiloxane, a trimethylsiloxy-terminated poly(methylhydrogensiloxane), a trimethylsiloxy-terminated poly(dimethylsiloxane/methylhydrogensiloxane), a dimethylhydrogensiloxy-terminated poly(methylhydrogensiloxane), and a resin including HMe₂SiO_{1/2} units, Me₃SiO_{1/2} units, and SiO_{4/2} units, wherein Me is methyl.

The organohydrogensiloxane can also be an organohydrogenpolysiloxane resin. The organohydrogenpolysiloxane resin is typically a copolymer including R⁴SiO_{3/2} units, i.e., T units, and/or SiO_{4/2} units, i.e., Q units, in combination with R¹R⁴₂SiO_{1/2} units, i.e., M units, and/or R⁴₂SiO_{2/2} units, i.e., D units, wherein R¹ is as described and exemplified above. For example, the organohydrogenpolysiloxane resin can be a DT resin, an MT resin, an MDT resin, a DTQ resin, and MTQ resin, and MDTQ resin, a DQ resin, an MQ resin, a DTQ resin, an MTQ resin, or an MDQ resin.

The group represented by R⁴ is either R¹ or an organosilylalkyl group having at least one silicon-bonded hydrogen atom. Examples of organosilylalkyl groups represented by R⁴ include, but are not limited to, groups having a formula selected from the following structures:

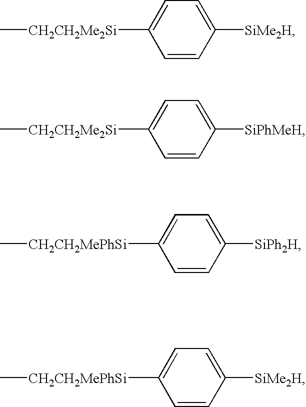

—CH₂CH₂SiMe₂H, —CH₂CH₂SiMe₂CₙH₂ₙSiMe₂H, —CH₂CH₂SiMe₂CₙH₂ₙSiMePhH, —CH₂CH₂SiMePhH, —CH₂CH₂SiPh₂H, —CH₂CH₂SiMePhCₙH₂ₙSiPh₂H, —CH₂CH₂SiMePhCₙH₂ₙSiMe₂H, —CH₂CH₂SiMePhOSiMePhH, and —CH₂CH₂SiMePhOSiPh(OSiMePhH)₂,
wherein Me is methyl, Ph is phenyl, and the subscript n has a value of from 2 to 10. Typically, at least 50 mol %, alternatively at least 65 mol %, alternatively at least 80 mol % of the groups represented by R⁴ in the organohydrogenpolysiloxane resin are organosilylalkyl groups having at least one silicon-bonded hydrogen atom. As used herein, the mol % of organosilylalkyl groups in R⁴ is defined as a ratio of the number of moles of silicon-bonded organosilylalkyl groups in the silicone resin to the total number of moles of the R⁴ groups in the resin, multiplied by 100.

The organohydrogenpolysiloxane resin typically has the formula:

(R¹R⁴₂SiO_{1/2})_{w}(R⁴₂SiO_{2/2})ₓ(R⁴SiO_{3/2})_{y}(SiO_{4/2})_{z} (III)

wherein R¹, R⁴, w, x, y, and z are each as defined and exemplified above.

Specific examples of organohydrogenpolysiloxane resins represent by formula (III) above include, but are not limited to, resins having the following formulae:

((HMe₂SiC₆H₄SiMe₂CH₂CH₂)₂MeSiO_{1/2})_{0.12}(PhSiO_{3/2})_{0.88},

((HMe₂SiC₆H₄SiMe₂CH₂CH₂)₂MeSiO_{1/2})_{0.17}(PhSiO_{3/2})_{0.83},

((HMe₂SiC₆H₄SiMe₂CH₂CH₂)₂MeSiO_{1/2})_{0.17}(MeSiO_{3/2})_{0.17}(PhSiO_{3/2})_{0.66},

((HMe₂SiC₆H₄SiMe₂CH₂CH₂)₂MeSiO_{1/2})_{0.15}(PhSiO_{3/2})_{0.75}(SiO_{4/2})_{0.10},

and

((HMe₂SiC₆H₄SiMe₂CH₂CH₂)₂MeSiO_{1/2})_{0.08}((HMe₂SiC₆H₄SiMe₂CH₂CH₂)Me₂SiO_{1/2})_{0.06}(PhSiO_{3/2})_{0.86},

wherein Me is methyl, Ph is phenyl, C₆H₄ denotes a para-phenylene group, and the numerical subscripts outside the parenthesis denote mole fractions. The sequence of units in the preceding formulae is not to be viewed in any way as limiting to the scope of the invention.

Specific examples of organohydrogenpolysiloxane resins include, but are not limited to, resins having the following formulae:

((HMe₂SiC₆H₄SiMe₂CH₂CH₂)₂MeSiO_{1/2})_{0.12}(PhSiO_{3/2})_{0.88},

((HMe₂SiC₆H₄SiMe₂CH₂CH₂)₂MeSiO_{1/2})_{0.17}(PhSiO_{3/2})_{0.83},

((HMe₂SiC₆H₄SiMe₂CH₂CH₂)₂MeSiO_{1/2})_{0.17}(MeSiO_{3/2})_{0.17}(PhSiO_{3/2})_{0.66},

((HMe₂SiC₆H₄SiMe₂CH₂CH₂)₂MeSiO_{1/2})_{0.15}(PhSiO_{3/2})_{0.75}(SiO_{4/2})_{0.10},

and

((HMe₂SiC₆H₄SiMe₂CH₂CH₂)₂MeSiO_{1/2})_{0.08}((HMe₂SiC₆H₄SiMe₂CH₂CH₂)Me₂SiO_{1/2})_{0.06}(PhSiO_{3/2})_{0.86},

where Me is methyl, Ph is phenyl, C₆H₄ denotes a para-phenylene group, and the numerical subscripts outside the parenthesis denote mole fractions. The sequence of units in the preceding formulae is not to be viewed in any way as limiting to the scope of the invention.

The organohydrogenpolysiloxane resin having the formula (III) can be prepared by reacting a reaction mixture including (a) a silicone resin having the formula (R¹_{R}²₂SiO_{1/2})_{w}(R²₂SiO_{2/2})ₓ(R²SiO_{3/2})_{y}(SiO_{4/2})_{z} represented by formula (I) above and an organosilicon compound (b) having an average of from two to four silicon-bonded hydrogen atoms per molecule and a molecular weight less than 1,000, in the presence of (c) a hydrosilylation catalyst and, optionally, (d) an organic solvent, wherein R¹, R², w, x, y, and z are each as defined and exemplified above, provided the silicone resin (a) has an average of at least two silicon-bonded alkenyl groups per molecule, and the mole ratio of silicon-bonded hydrogen atoms in (b) to alkenyl groups in (a) is from 1.5 to 5. Silicone resin (a) can be the same as or different than the specific silicone resin used as component (A) to form the hydrosilylation-cured silicone composition.

As set forth above, organosilicon compound (b) has an average of from two to four silicon-bonded hydrogen atoms per molecule. Alternatively, the organosilicon compound (b) has an average of from two to three silicon-bonded hydrogen atoms per molecule. As also set forth above, the organosilicon compound (b) typically has a molecular weight less than 1,000, alternatively less than 750, alternatively less than 500. The organosilicon compound (b) further includes silicon-bonded organic groups that may be selected from the group of hydrocarbyl groups and halogen-substituted hydrocarbyl groups, both free of aliphatic unsaturation, which are as described and exemplified above for R¹.

Organosilicon compound (b) can be an organohydrogensilane or an organohydrogensiloxane, each of which are defined and exemplified in detail above. Organosilicon compound (b) can further be a single organosilicon compound or a mixture comprising two or more different organosilicon compounds, each as described above. For example, organosilicon compound (B) can be a single organohydrogensilane, a mixture of two different organohydrogensilanes, a single organohydrogensiloxane, a mixture of two different organohydrogensiloxanes, or a mixture of an organohydrogensilane and an organohydrogensiloxane. The mole ratio of silicon-bonded hydrogen atoms in organosilicon compound (b) to alkenyl groups in silicone resin (a) is typically from 1.5 to 5, alternatively from 1.75 to 3, alternatively from 2 to 2.5.

Hydrosilylation catalyst (c) can be any of the well-known hydrosilylation catalysts comprising a platinum group metal (i.e., platinum, rhodium, ruthenium, palladium, osmium and iridium) or a compound containing a platinum group metal. Preferably, the platinum group metal is platinum, based on its high activity in hydrosilylation reactions.

Specific hydrosilylation catalysts suitable for (c) include the complexes of chloroplatinic acid and certain vinyl-containing organosiloxanes disclosed by Willing in U.S. Pat. No. 3,419,593, which is hereby incorporated by reference. A catalyst of this type is the reaction product of chloroplatinic acid and 1,3-diethenyl-1,1,3,3-tetramethyldisiloxane.

The hydrosilylation catalyst can also be a supported hydrosilylation catalyst comprising a solid support having a platinum group metal on the surface thereof. A supported catalyst can be conveniently separated from the organohydrogenpolysiloxane resin represented by formula (III), for example, by filtering the reaction mixture. Examples of supported catalysts include, but are not limited to, platinum on carbon, palladium on carbon, ruthenium on carbon, rhodium on carbon, platinum on silica, palladium on silica, platinum on alumina, palladium on alumina, and ruthenium on alumina.

The concentration of hydrosilylation catalyst (c) is sufficient to catalyze the addition reaction of silicone resin (a) with organosilicon compound (b). Typically, the concentration of hydrosilylation catalyst (c) is sufficient to provide from 0.1 to 1000 ppm of a platinum group metal, alternatively from 1 to 500 ppm of a platinum group metal, alternatively from 5 to 150 ppm of a platinum group metal, based on the combined weight of silicone resin (a) and organosilicon compound (b). The rate of reaction is very slow below 0.1 ppm of platinum group metal. The use of more than 1000 ppm of platinum group metal results in no appreciable increase in reaction rate, and is therefore uneconomical.

Organic solvent (d) is at least one organic solvent. The organic solvent (d) can be any aprotic or dipolar aprotic organic solvent that does not react with silicone resin (a), organosilicon compound (b), or the resulting organohydrogenpolysiloxane resin under the conditions of the present method, and is miscible with components (a), (b), and the organohydrogenpolysiloxane resin.

Examples of organic solvents (d) that are suitable for purposes of the present invention include, but are not limited to, saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; and halogenated aromatic hydrocarbons such as bromobenzene and chlorobenzene. Organic solvent (d) can be a single organic solvent or a mixture comprising two or more different organic solvents, each as described above. The concentration of organic solvent (d) is typically from 0 to 99% (w/w), alternatively from 30 to 80% (w/w), alternatively from 45 to 60% (w/w), based on the total weight of the reaction mixture.

The reaction to form the organohydrogenpolysiloxane resin represented by formula (III) can be carried out in any standard reactor suitable for hydrosilylation reactions. Suitable reactors include glass and Teflon-lined glass reactors. Preferably, the reactor is equipped with a means of agitation, such as stirring. Also, preferably, the reaction is carried out in an inert atmosphere, such as nitrogen or argon, in the absence of moisture.

The silicone resin (a), organosilicon compound (b), hydrosilylation catalyst (c), and, optionally, organic solvent (d), can be combined in any order. Typically, organosilicon compound (b) and hydrosilylation catalyst (c) are combined before the introduction of the silicone resin (a) and, optionally, organic solvent (d). The reaction is typically carried out at a temperature of from 0 to 150° C., alternatively from room temperature (˜23±2° C.) to 115° C. When the temperature is less than 0° C., the rate of reaction is typically very slow. The reaction time depends on several factors, such as the structures of the silicone resin (a) and the organosilicon compound (b), and the temperature. The time of reaction is typically from 1 to 24 h at a temperature of from room temperature (˜23±2° C.) to 150° C. The optimum reaction time can be determined by routine experimentation.

The organohydrogenpolysiloxane resin represented by formula (III) can be used without isolation or purification or the organohydrogenpolysiloxane resin can be separated from most of the organic solvent (d) by conventional methods of evaporation. For example, the reaction mixture can be heated under reduced pressure. Moreover, when the hydrosilylation catalyst (c) is a supported catalyst, as described above, the organohydrogenpolysiloxane resin can be readily separated from the hydrosilylation catalyst (c) by filtering the reaction mixture. However, the hydrosilylation catalyst may remain mixed with the organohydrogenpolysiloxane resin and be used as hydrosilylation catalyst (C).

The organosilicon compound (B) can be a single organosilicon compound or a mixture comprising two or more different organosilicon compounds, each as described above. For example, the organosilicon compound (B) can be a single organohydrogensilane, a mixture of two different organohydrogensilanes, a single organohydrogensiloxane, a mixture of two different organohydrogensiloxanes, or a mixture of an organohydrogensilane and an organohydrogensiloxane. In particular, the organosilicon compound (B) can be a mixture comprising the organohydrogenpolysiloxane resin having the formula (III) in an amount of at least 0.5% (w/w), alternatively at least 50% (w/w), alternatively at least 75% (w/w), based on the total weight of the organosilicon compound (B), with the organosilicon compound (B) further comprising an organohydrogensilane and/or organohydrogensiloxane, the latter different from the organohydrogenpolysiloxane resin.

The concentration of organosilicon compound (B) is sufficient to cure (cross-link) the silicone resin (A). The exact amount of organosilicon compound (B) depends on the desired extent of cure. The concentration of organosilicon compound (B) is typically sufficient to provide from 0.4 to 2 moles of silicon-bonded hydrogen atoms, alternatively from 0.8 to 1.5 moles of silicon-bonded hydrogen atoms, alternatively from 0.9 to 1.1 moles of silicon-bonded hydrogen atoms, per mole of alkenyl groups in silicone resin (A).

Hydrosilylation catalyst (C) includes at least one hydrosilylation catalyst that promotes the reaction between silicone resin (A) and organosilicon compound (B). In one embodiment, the hydrosilylation catalyst (C) may be the same as the hydrosilylation catalyst (c) described above for producing the organohydrogenpolysiloxane resin. In addition, the hydrosilylation catalyst (C) can also be a microencapsulated platinum group metal-containing catalyst comprising a platinum group metal encapsulated in a thermoplastic resin. Microencapsulated hydrosilylation catalysts and methods of preparing them are well known in the art, as exemplified in U.S. Pat. No. 4,766,176 and the references cited therein, and U.S. Pat. No. 5,017,654. The hydrosilylation catalyst (C) can be a single catalyst or a mixture comprising two or more different catalysts that differ in at least one property, such as structure, form, platinum group metal, complexing ligand, and thermoplastic resin.

In another embodiment, the hydrosilylation catalyst (C) may be at least one photoactivated hydrosilylation catalyst. The photoactivated hydrosilylation catalyst can be any hydrosilylation catalyst capable of catalyzing the hydrosilylation of the silicone resin (A) and the organosilicon compound (B) upon exposure to radiation having a wavelength of from 150 to 800 nm. The photoactivated hydrosilylation catalyst can be any of the well-known hydrosilylation catalysts comprising a platinum group metal or a compound containing a platinum group metal. The platinum group metals include platinum, rhodium, ruthenium, palladium, osmium and iridium. Typically, the platinum group metal is platinum, based on its high activity in hydrosilylation reactions. The suitability of particular photoactivated hydrosilylation catalyst for use in the silicone composition of the present invention can be readily determined by routine experimentation.

Specific examples of photoactivated hydrosilylation catalysts suitable for purposes of the present invention include, but are not limited to, platinum(II) (3-diketonate complexes such as platinum(II) bis(2,4-pentanedioate), platinum(II) bis(2,4-hexanedioate), platinum(II) bis(2,4-heptanedioate), platinum(II) bis(1-phenyl-1,3-butanedioate, platinum(II) bis(1,3-diphenyl-1,3-propanedioate), platinum(II) bis(1,1,1,5,5,5-hexafluoro-2,4-pentanedioate); (η-cyclopentadienyl)trialkylplatinum complexes, such as (Cp)trimethylplatinum, (Cp)ethyldimethylplatinum, (Cp)triethylplatinum, (chloro-Cp)trimethylplatinum, and (trimethylsilyl-Cp)trimethylplatinum, where Cp represents cyclopentadienyl; triazene oxide-transition metal complexes, such as Pt[C₆H₅NNNOCH₃]₄, Pt[p-CN—C₆H₄NNNOC₆H₁₁]₄, Pt[p-H₃COC₆H₄NNNOC₆H₁₁]₄, Pt[p-CH₃(CH₂)ₓ—C₆H₄NNNOCH₃]₄, 1,5-cyclooctadiene.Pt[p-CN—C₆H₄NNNOC₆H₁₁]₂, 1,5-cyclooctadiene.Pt[p-CH₃O—C₆H₄NNNOCH₃]₂, [(C₆H₅)₃P]₃Rh[p-CN—C₆H₄NNNOC₆H₁₁], and Pd[p-CH₃(CH₂)ₓ—C₆H₄NNNOCH₃]₂, where x is 1, 3, 5, 11, or 17; (η-diolefin)(σ-aryl)platinum complexes, such as (η⁴-1,5-cyclooctadienyl)diphenylplatinum, η⁴-1,3,5,7-cyclooctatetraenyl)diphenylplatinum, (η⁴-2,5-norboradienyl)diphenylplatinum, (η⁴-1,5-cyclooctadienyl)bis-(4-dimethylaminophenyl)platinum, (η⁴-1,5-cyclooctadienyl)bis-(4-acetylphenyl)platinum, and (η⁴-1,5-cyclooctadienyl)bis-(4-trifluormethylphenyl)platinum. Preferably, the photoactivated hydrosilylation catalyst is a Pt(II) β-diketonate complex and more preferably the catalyst is platinum(II) bis(2,4-pentanedioate). The hydrosilylation catalyst (C) can be a single photoactivated hydrosilylation catalyst or a mixture comprising two or more different photoactivated hydrosilylation catalysts.

Methods of preparing photoactivated hydrosilylation catalysts are well known in the art. For example, methods of preparing platinum(II) β-diketonates are reported by Guo et al. (Chemistry of Materials, 1998, 10, 531-536). Methods of preparing (η-cyclopentadienyl)-trialkylplatinum complexes and are disclosed in U.S. Pat. No. 4,510,094. Methods of preparing triazene oxide-transition metal complexes are disclosed in U.S. Pat. No. 5,496,961. And, methods of preparing (η-diolefin)(σ-aryl)platinum complexes are taught in U.S. Pat. No. 4,530,879.

The concentration of the hydrosilylation catalyst (C) is sufficient to catalyze the addition reaction of the silicone resin (A) and the organosilicon compound (B). The concentration of the hydrosilylation catalyst (C) is sufficient to provide typically from 0.1 to 1000 ppm of platinum group metal, alternatively from 0.5 to 100 ppm of platinum group metal, alternatively from 1 to 25 ppm of platinum group metal, based on the combined weight of the silicone resin (A) and the organosilicon compound (B).

Optionally, the hydrosilylation-cured silicone composition further includes (D) a silicone rubber having a formula selected from the group of:

(i) R¹R²₂SiO(R²₂SiO)ₐSiR²₂R¹;

and

(ii) R⁵R¹₂SiO(R¹R⁵SiO)_{b}SiR¹₂R⁵;

wherein R¹ and R² are as defined and exemplified above, R⁵ is R¹ or H, subscripts a and b each have a value of from 1 to 4, from 2 to 4 or from 2 to 3, and w, x, y, and z are also as defined and exemplified above, provided the silicone resin and the silicone rubber (D)(i) each have an average of at least two silicon-bonded alkenyl groups per molecule, the silicone rubber (D)(ii) has an average of at least two silicon-bonded hydrogen atoms per molecule, and the mole ratio of silicon-bonded alkenyl groups or silicon-bonded hydrogen atoms in the silicone rubber (D) to silicon-bonded alkenyl groups in the silicone resin (A) is from 0.01 to 0.5.

Specific examples of silicone rubbers suitable for use as component (D)(i) include, but are not limited to, silicone rubbers having the following formulae:

ViMe₂SiO(Me₂SiO)ₐSiMe₂Vi,

ViMe₂SiO(Ph₂SiO)ₐSiMe₂Vi,

and

ViMe₂SiO(PhMeSiO)ₐSiMe₂Vi,

wherein Me is methyl, Ph is phenyl, Vi is vinyl, and the subscript a has a value of from 1 to 4. Silicone rubber (D)(i) can be a single silicone rubber or a mixture comprising two or more different silicone rubbers that each satisfy the formula for (D)(i).

Specific examples of silicone rubbers suitable for use as silicone rubber (D)(ii) include, but are not limited to, silicone rubbers having the following formulae:

HMe₂SiO(Me₂SiO)_{b}SiMe₂H,

HMe₂SiO(Ph₂SiO)_{b}SiMe₂H,

HMe₂SiO(PhMeSiO)_{b}SiMe₂H,

and

HMe₂SiO(Ph₂SiO)₂(Me₂SiO)₂SiMe₂H,

wherein Me is methyl, Ph is phenyl, and the subscript b has a value of from 1 to 4. Component (D)(ii) can be a single silicone rubber or a mixture comprising two or more different silicone rubbers that each satisfy the formula for (D)(ii).

The mole ratio of silicon-bonded alkenyl groups or silicon-bonded hydrogen atoms in the silicone rubber (D) to silicon-bonded alkenyl groups in the silicone resin (A) is typically from 0.01 to 0.5, alternatively from 0.05 to 0.4, alternatively from 0.1 to 0.3.

When the silicone rubber (D) is (D)(i), the concentration of the organosilicon compound (B) is such that the ratio of the number of moles of silicon-bonded hydrogen atoms in the organosilicon compound (B) to the sum of the number of moles of silicon-bonded alkenyl groups in the silicone resin (A) and the silicone rubber (D)(i) is typically from 0.4 to 2, alternatively from 0.8 to 1.5, alternatively from 0.9 to 1.1. Furthermore, when the silicone rubber (D) is (D)(ii), the concentration of the organosilicon compound (B) is such that the ratio of the sum of the number of moles of silicon-bonded hydrogen atoms in the organosilicon compound (B) and the silicone rubber (D)(ii) to the number of moles of silicon-bonded alkenyl groups in the silicone resin (A) is typically from 0.4 to 2, alternatively from 0.8 to 1.5, alternatively from 0.9 to 1.1.

Methods of preparing silicone rubbers containing silicon-bonded alkenyl groups or silicon-bonded hydrogen atoms are well known in the art; many of these compounds are commercially available.

In another embodiment of the present invention, the hydrosilylation-cured silicone composition comprises the reaction product of (A′) a rubber-modified silicone resin and the organosilicon compound (B), in the presence of (C) the catalytic amount of the hydrosilylation catalyst. The rubber-modified silicone resin (A′) may be prepared by reacting the silicone resin (A) and a silicone rubber (D)(iii) having the following formulae:

R⁵R¹₂SiO(R¹R⁵SiO)_{c}SiR¹₂R⁵, R¹R²₂SiO(R²₂SiO)_{d}SiR²₂R¹,

wherein R¹ and R⁵ are as defined and exemplified above and c and d each have a value of from 4 to 1000, alternatively from 10 to 500, alternatively from 10 to 50, in the presence of the hydrosilylation catalyst (c) and, optionally, an organic solvent, provided the silicone resin (A) has an average of at least two silicon-bonded alkenyl groups per molecule, the silicone rubber (D)(iii) has an average of at least two silicon-bonded hydrogen atoms per molecule, and the mole ratio of silicon-bonded hydrogen atoms in the silicone rubber (D)(iii) to silicon-bonded alkenyl groups in silicone resin (A) is from 0.01 to 0.5. When organic solvent is present, the rubber-modified silicone resin (A′) is miscible in the organic solvent and does not form a precipitate or suspension.

The silicone resin (A), silicone rubber (D)(iii), hydrosilylation catalyst (c), and organic solvent can be combined in any order. Typically, the silicone resin (A), silicone rubber (D)(iii), and organic solvent are combined before the introduction of the hydrosilylation catalyst (c).

The reaction is typically carried out at a temperature of from room temperature (˜23±2° C.) to 150° C., alternatively from room temperature to 100° C. The reaction time depends on several factors, including the structures of the silicone resin (A) and the silicone rubber (D)(iii) and the temperature. The components are typically allowed to react for a period of time sufficient to complete the hydrosilylation reaction. This means the components are typically allowed to react until at least 95 mol %, alternatively at least 98 mol %, alternatively at least 99 mol %, of the silicon-bonded hydrogen atoms originally present in the silicone rubber (D)(iii) have been consumed in the hydrosilylation reaction, as determined by FTIR spectrometry. The time of reaction is typically from 0.5 to 24 h at a temperature of from room temperature (˜23±2° C.) to 100° C. The optimum reaction time can be determined by routine experimentation.

The mole ratio of silicon-bonded hydrogen atoms in the silicone rubber (D)(iii) to silicon-bonded alkenyl groups in the silicone resin (A) is typically from 0.01 to 0.5, alternatively from 0.05 to 0.4, alternatively from 0.1 to 0.3.

The concentration of the hydrosilylation catalyst (c) is sufficient to catalyze the addition reaction of the silicone resin (A) with the silicone rubber (D)(iii). Typically, the concentration of the hydrosilylation catalyst (c) is sufficient to provide from 0.1 to 1000 ppm of a platinum group metal, based on the combined weight of the resin and the rubber.

The concentration of the organic solvent is typically from 0 to 95% (w/w), alternatively from 10 to 75% (w/w), alternatively from 40 to 60% (w/w), based on the total weight of the reaction mixture.

The rubber-modified silicone resin (A′) can be used without isolation or purification or the rubber-modified silicone resin (A′) can be separated from most of the solvent by conventional methods of evaporation. For example, the reaction mixture can be heated under reduced pressure. Moreover, when the hydrosilylation catalyst (c) is a supported catalyst, described above, the rubber-modified silicone resin (A′) can be readily separated from the hydrosilylation catalyst (c) by filtering the reaction mixture. However, when the rubber-modified silicone resin (A′) is not separated from the hydrosilylation catalyst (c) used to prepare the rubber-modified silicone resin (A′), the hydrosilylation catalyst (c) may be used as the hydrosilylation catalyst (C).

The hydrosilylation-cured silicone composition of the present invention can comprise additional ingredients, as known in the art. Examples of additional ingredients include, but are not limited to, hydrosilylation catalyst inhibitors, such as 3-methyl-3-penten-1-yne, 3,5-dimethyl-3-hexen-1-yne, 3,5-dimethyl-1-hexyn-3-ol, 1-ethynyl-1-cyclohexanol, 2-phenyl-3-butyn-2-ol, vinylcyclosiloxanes, and triphenylphosphine; adhesion promoters, such as the adhesion promoters taught in U.S. Pat. Nos. 4,087,585 and 5,194,649; dyes; pigments; anti-oxidants; heat stabilizers; UV stabilizers; flame retardants; flow control additives; and diluents, such as organic solvents and reactive diluents.

As an alternative to the hydrosilylation-cured silicone composition, condensation-cured silicone compositions are also suitable for the silicone composition of the present invention.

The condensation-cured silicone composition typically includes the reaction product of a silicone resin (A″) having silicon-bonded hydroxy or hydrolysable groups and, optionally, a cross-linking agent (B′) having silicon-bonded hydrolysable groups, and optionally a condensation catalyst (C′). The silicone resin (A″) is typically a copolymer containing T and/or Q siloxane units in combination with M and/or D siloxane units.

The condensation-cured silicone composition may be any condensation-cured silicone composition as known in the art. However, certain condensation-cured silicone compositions are particularly suitable for purposes of the present invention. According to one embodiment, the silicone resin (A″) has the formula:

(R¹R⁶₂SiO_{1/2})_{w′}(R⁶₂SiO_{2/2})_{x′}(R⁶SiO_{3/2})_{y′}(SiO_{4/2})_{z′} (IV)

wherein R¹ is as defined and exemplified above, R⁶ is R¹, —H, —OH, or a hydrolysable group, and w′ is from 0 to 0.8, preferably from 0.02 to 0.75, and more preferably from 0.05 to 0.3, x′ is from 0 to 0.95, preferably from 0.05 to 0.8, and more preferably from 0.1 to 0.3, y′ is from 0 to 1, preferably from 0.25 to 0.8, and more preferably from 0.5 to 0.8, and z′ is from 0 to 0.99, preferably from 0.2 to 0.8, and more preferably from 0.4 to 0.6, and the silicone resin (A″) has an average of at least two silicon-bonded hydrogen atoms, hydroxy groups, or hydrolysable groups per molecule. As used herein the term “hydrolysable group” means the silicon-bonded group reacts with water in the absence of a catalyst at any temperature from room temperature (˜23±2° C.) to 100° C. within several minutes, for example thirty minutes, to form a silanol (Si—OH) group. Examples of hydrolysable groups represented by R⁶ include, but are not limited to, —Cl, —Br, —OR⁷, —OCH₂CH₂OR⁷, CH₃C(═O)O—, Et(Me)C═N—O—, CH₃C(═O)N(CH₃)—, and —ONH₂, wherein R⁷ is C₁ to C₈ hydrocarbyl or C₁ to C₈ halogen-substituted hydrocarbyl.

The hydrocarbyl and halogen-substituted hydrocarbyl groups represented by R⁷ typically have from 1 to 8 carbon atoms, alternatively from 3 to 6 carbon atoms. Acyclic hydrocarbyl and halogen-substituted hydrocarbyl groups containing at least 3 carbon atoms can have a branched or unbranched structure. Examples of hydrocarbyl groups represented by R⁷ include, but are not limited to, unbranched and branched alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, and octyl; cycloalkyl, such as cyclopentyl, cyclohexyl, and methylcyclohexyl; phenyl; alkaryl, such as tolyl and xylyl; aralkyl, such as benzyl and phenethyl; alkenyl, such as vinyl, allyl, and propenyl; arylalkenyl, such as styryl; and alkynyl, such as ethynyl and propynyl. Examples of halogen-substituted hydrocarbyl groups represented by R⁷ include, but are not limited to, 3,3,3-trifluoropropyl, 3- chloropropyl, chlorophenyl, and dichlorophenyl.

Typically, at least 5 mol %, alternatively at least 15 mol %, alternatively at least 30 mol % of the groups R⁶ in the silicone resin are hydrogen, hydroxy, or a hydrolysable group. As used herein, the mol % of groups in R⁶ is defined as a ratio of the number of moles of silicon-bonded groups in the silicone resin (A″) to the total number of moles of the R⁶ groups in the silicone resin (A″), multiplied by 100.

Specific examples of cured silicone resins formed from silicone resin (A″) include, but are not limited to, cured silicone resins having the following formulae:

(MeSiO_{3/2})ₙ,

(PhSiO_{3/2})ₙ,

(Me₃SiO_{1/2})_{0.8}(SiO_{4/2})_{0.2},

(MeSiO_{3/2})_{0.67}(PhSiO_{3/2})_{0.33},

(MeSiO_{3/2})_{0.45}(PhSiO_{3/2})_{0.40}(Ph₂SiO_{2/2})_{0.1}(PhMeSiO_{2/2})_{0.05},

(PhSiO_{3/2})_{0.4}(MeSiO_{3/2})_{0.45}(PhSiO_{3/2})_{0.1}(PhMeSiO_{2/2})_{0.05},

and

(PhSiO_{3/2})_{0.4}(MeSiO_{3/2})_{0.1}(PhMeSiO_{2/2})_{0.5},

wherein Me is methyl, Ph is phenyl, the numerical subscripts outside the parenthesis denote mole fractions, and the subscript n has a value such that the silicone resin has a number-average molecular weight of from 500 to 50,000. The sequence of units in the preceding formulae is not to be viewed in any way as limiting to the scope of the invention.

As set forth above, the silicone resin (A″) represented by formula (IV) typically has a number-average molecular weight (Mₙ) of from 500 to 50,000. Alternatively, the silicone resin (A″) may have a Mₙ of at least 300, alternatively 1,000 to 3,000, where the molecular weight is determined by gel permeation chromatography employing a low angle laser light scattering detector, or a refractive index detector and silicone resin (MQ) standards.

The viscosity of the silicone resin (A″) at 25° C. is typically from 0.01 Pa·s to solid, alternatively from 0.1 to 100,000 Pa·s, alternatively from 1 to 1,000 Pa·s.

Methods of preparing silicone resins (A″) represented by formula (IV) are well known in the art; many of these resins are commercially available. Silicone resins (A″) represented by formula (IV) are typically prepared by cohydrolyzing the appropriate mixture of chlorosilane precursors in an organic solvent, such as toluene. For example, a silicone resin including R¹R⁶₂SiO_{1/2} units and R⁶SiO_{3/2} units can be prepared by cohydrolyzing a first compound having the formula R¹R⁶₂SiCl and a second compound having the formula R⁶SiCl₃ in toluene, where R¹ and R⁶ are as defined and exemplified above. The cohydrolyzing process is described above in terms of the hydrosilylation-cured silicone composition. The cohydrolyzed reactants can be further “bodied” to a desired extent to control the amount of crosslinkable groups and viscosity.

The Q units in formula (IV) can be in the form of discrete particles in the silicone resin (A″). The particle size is typically from 1 nm to 20 gm. Examples of these particles include, but not limited to, silica (SiO_{4/2}) particles of 15 nm in diameter.

The condensation cured silicone composition can further contain an inorganic filler such as silica, alumina, calcium carbonate, and mica. The inorganic filler, when present, is in particulate form.

In another embodiment, the condensation-cured silicone composition comprises the reaction product of a rubber-modified silicone resin (A′″) and the other optional components. The rubber-modified silicone resin (A′″) may be prepared by reacting an organosilicon compound selected from (i) a silicone resin having the formula (R¹R⁶₂SiO_{1/2})_{w}(R⁶₂SiO_{2/2})ₓ(R⁶SiO_{3/2})_{y}(SiO_{4/2})_{z} and (ii) hydrolysable precursors of (i), and (iii) a silicone rubber having the formula R⁸₃SiO(R¹R⁸SiO)ₘSiR⁸₃ in the presence of water, (iv) a condensation catalyst, and (v) an organic solvent, wherein R¹ and R⁶ are as defined and exemplified above, R⁸ is R¹ or a hydrolysable group, m is from 2 to 1,000, alternatively from 4 to 500, alternatively from 8 to 400, and w, x, y, and z are as defined and exemplified above, and silicone resin (i) has an average of at least two silicon-bonded hydroxy or hydrolysable groups per molecule, the silicone rubber (iii) has an average of at least two silicon-bonded hydrolysable groups per molecule, and the mole ratio of silicon-bonded hydrolysable groups in the silicone rubber (iii) to silicon-bonded hydroxy or hydrolysable groups in the silicone resin (i) is from 0.01 to 1.5, alternatively from 0.05 to 0.8, alternatively from 0.2 to 0.5.

Typically at least 5 mol %, alternatively at least 15 mol %, alternatively at least 30 mol % of the groups R⁶ in the silicone resin (i) are hydroxy or hydrolysable groups.

The silicone resin (i) typically has a number-average molecular weight (Mₙ) of at least 300, alternatively from 500 to 10,000, alternatively 1,000 to 3,000, where the molecular weight is determined by gel permeation chromatography employing a low angle laser light scattering detector, or a refractive index detector and silicone resin (MQ) standards.

Specific examples of cured silicone resins formed from silicone resin (i) include, but are not limited to, cured silicone resins having the following formulae:

(MeSiO_{3/2})ₙ,

(PhSiO_{3/2})ₙ,

(PhSiO_{3/2})_{0.4}(MeSiO_{3/2})_{0.45}(PhSiO_{3/2})_{0.1}(PhMeSiO_{2/2})_{0.05},

and

(PhSiO_{3/2})_{0.3}(SiO_{4/2})_{0.1}(Me₂SiO_{2/2})_{0.2}(Ph₂SiO_{2/2})_{0.4},

where Me is methyl, Ph is phenyl, the numerical subscripts outside the parenthesis denote mole fractions, and the subscript n has a value such that the silicone resin has a number-average molecular weight of from 500 to 50,000. The sequence of units in the preceding formulae is not to be viewed in any way as limiting to the scope of the invention. Silicone resin (i) can be a single silicone resin or a mixture comprising two or more different silicone resins, each having the specified formula.

As used herein, the term “hydrolysable precursors” refers to silanes having hydrolysable groups that are suitable for use as starting materials (precursors) for preparation of the silicone resin (i). The hydrolysable precursors (ii) can be represented by the formulae R¹R⁸₂SiX, R⁸₂SiX₂, R⁸SiX₃, and SiX₄, wherein R¹, R⁸, and X are as defined and exemplified above.

Specific examples of hydrolysable precursors (ii) include, but are not limited to, silanes having the formulae:

Me₂ViSiCl,

Me₃SiCl,

MeSi(OEt)₃,

PhSiCl₃,

MeSiCl₃,

Me₂SiCl₂,

PhMeSiCl₂,

SiCl₄,

Ph₂SiCl₂,

PhSi(OMe)₃,

MeSi(OMe)₃,

PhMeSi(OMe)₂,

and

Si(OEt)₄,

wherein Me is methyl, Et is ethyl, and Ph is phenyl.

Specific examples of silicone rubbers (iii) include, but are not limited to, silicone rubbers having the following formulae:

(EtO)₃SiO(Me₂SiO)₅₅Si(OEt)₃,

(EtO)₃SiO(Me₂SiO)₁₆Si(OEt)₃,

(EtO)₃SiO(Me₂SiO)₃₈₆Si(OEt)₃,

and

(EtO)₂MeSiO(PhMeSiO)₁₀SiMe(OEt)₂,

wherein Me is methyl and Et is ethyl.

The reaction is typically carried out at a temperature of from room temperature (˜23±2° C.) to 180° C., alternatively from room temperature to 100° C.

The reaction time depends on several factors, including the structures of the silicone resin (i) and the silicone rubber (iii), and the temperature. The components are typically allowed to react for a period of time sufficient to complete the condensation reaction. This means the components are allowed to react until at least 95 mol %, alternatively at least 98 mol %, alternatively at least 99 mol %, of the silicon-bonded hydrolysable groups originally present in the silicone rubber (iii) have been consumed in the condensation reaction , as determined by ²⁹Si NMR spectrometry. The time of reaction is typically from 1 to 30 h at a temperature of from room temperature (˜23±2° C.) to 100° C. The optimum reaction time can be determined by routine experimentation.

Suitable condensation catalysts (iv) are described in further detail below, and suitable organic solvents (v) are described above in the context of rubber-modified silicone resin (A′) above. The concentration of the condensation catalyst (iv) is sufficient to catalyze the condensation reaction of the silicone resin (i) with the silicone rubber (iii). Typically, the concentration of the condensation catalyst (iv) is from 0.01 to 2% (w/w), alternatively from 0.01 to 1% (w/w), alternatively from 0.05 to 0.2% (w/w), based on the weight of the silicon resin (i). The concentration of the organic solvent (v) is typically from 10 to 95% (w/w), alternatively from 20 to 85% (w/w), alternatively from 50 to 80% (w/w), based on the total weight of the reaction mixture.

The concentration of water in the reaction mixture depends on the nature of the groups R⁸ in the organosilicon compound and the nature of the silicon-bonded hydrolysable groups in the silicone rubber. When the silicone resin (i) contains hydrolysable groups, the concentration of water is sufficient to effect hydrolysis of the hydrolysable groups in the silicon resin (i) and the silicone rubber (iii). For example, the concentration of water is typically from 0.01 to 3 moles, alternatively from 0.05 to 1 moles, per mole of hydrolysable group in the silicone resin (i) and the silicone rubber (iii) combined. When the silicone resin (i) does not contain hydrolysable groups, only a trace amount, e.g., 100 ppm, of water is required in the reaction mixture. Trace amounts of water are normally present in the reactants and/or solvent.

As set forth above, the condensation-cured silicone composition can further comprise the reaction product of the cross-linking agent (13′). The cross-linking agent (B′) can have the formula R⁷_{q}SiX_{4-q}, wherein R⁷ is C₁ to C₈ hydrocarbyl or C₁ to C₈ halogen-substituted hydrocarbyl, X is a hydrolysable group, and q is 0 or 1. The hydrocarbyl and halogen-substituted hydrocarbyl groups represented by R⁷, and the hydrolysable groups represented by X are as described and exemplified above.

Specific examples of cross-linking agents (B′) include, but are not limited to, alkoxy silanes such as MeSi(OCH₃)₃, CH₃Si(OCH₂CH₃)₃, CH₃ Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂═CHSi(OCOCH₃)₃; organoiminooxysilanes such as CH₃Si[O—N═C(CH₃)CH₂CH₃]₃, Si[O—N═C(CH₃)CH₂CH₃]₄, and CH₂═CHSi[O—N═C(CH₃)CH₂CH₃]₃; organoacetamidosilanes such as CH₃Si[NHC(═O)CH₃]₃ and C₆H₅Si[NHC(═O)CH₃]₃; amino silanes such as CH₃Si[NH(s-C₄H₉)]₃ and CH₃Si(NHC₆H₁₁)₃; and organoaminooxysilanes.

The cross-linking agent (B′) can be a single silane or a mixture of two or more different silanes, each as described above. Also, methods of preparing tri- and tetra-functional silanes are well known in the art; many of these silanes are commercially available.

When used, the concentration of the cross-linking agent (B′) prior to formation of the condensation-cured silicone composition is sufficient to cure (cross-link) the condensation-cured silicone resin. The exact amount of the cross-linking agent (B′) depends on the desired extent of cure, which generally increases as the ratio of the number of moles of silicon-bonded hydrolysable groups in the cross-linking agent (B′) to the number of moles of silicon-bonded hydrogen atoms, hydroxy groups, or hydrolysable groups in the silicone resin (A″) increases. Typically, the concentration of the cross-linking agent (B′) is sufficient to provide from 0.2 to 4 moles of silicon-bonded hydrolysable groups per mole of silicon-bonded hydrogen atoms, hydroxy groups, or hydrolysable groups in the silicone resin (A″). The optimum amount of the cross-linking agent (B′) can be readily determined by routine experimentation.

Condensation catalyst (C′) can be any condensation catalyst typically used to promote condensation of silicon-bonded hydroxy (silanol) groups to form Si—O—Si linkages. Examples of condensation catalysts include, but are not limited to, amines; and complexes of lead, tin, zinc, and iron with carboxylic acids. In particular, the condensation catalyst (C′) can be selected from tin(II) and tin(IV) compounds such as tin dilaurate, tin dioctoate, and tetrabutyl tin; and titanium compounds such as titanium tetrabutoxide.

When present, the concentration of the condensation catalyst (C′) is typically from 0.1 to 10% (w/w), alternatively from 0.5 to 5% (w/w), alternatively from 1 to 3% (w/w), based on the total weight of the silicone resin (A″).

When the condensation-cured silicone composition is formed in the presence of the condensation catalyst (C′), the condensation-cured silicone composition is typically formed from a two-part composition where the silicone resin (A″) and condensation catalyst (C′) are in separate parts.

The condensation-cured silicone composition of the present invention can comprise additional ingredients, as known in the art and as described above for the hydrosilylation-cured silicone composition.

In yet another embodiment, the silicone composition may be a free radical-cured silicone composition. Examples of free radical-cured silicone compositions include peroxide-cured silicone compositions, radiation-cured silicone compositions containing a free radical photoinitiator, and high energy radiation-cured silicone compositions. Typically, the free radical-cured silicone composition comprises the reaction product of a silicone resin (A′″) and, optionally, a cross-linking agent (B″) and/or a free radical initiator (C″) (e.g., a free radical photoinitiator or organic peroxide).

The silicone resin (A′″) can be any silicone resin that can be cured (i.e., cross-linked) by at least one method selected from (i) exposing the silicone resin to radiation having a wavelength of from 150 to 800 nm in the presence of a free radical photoinitiator, (ii) heating the silicone resin (A′″) in the presence of an organic peroxide, and (iii) exposing the silicone resin (A′″) to an electron beam. The silicone resin (A′″) is typically a copolymer containing T siloxane units and/or Q siloxane units in combination with M and/or D siloxane units.

For example, the silicone resin (A′″) may have the formula:

(R¹R⁹₂SiO_{1/2})_{w″}(R⁹₂SiO_{2/2})_{x″}(R⁹SiO_{3/2})_{y″}(SiO_{4/2})_{z″,}

wherein R¹ is as defined and exemplified above, R⁹ is R¹, alkenyl, or alkynyl, w″ is from 0 to 0.99, x″ is from 0 to 0.99, y″ is from 0 to 0.99, and z″ is from 0 to 0.85, and w″+x″+y″+z″=1.

The alkenyl groups represented by R⁹, which may be the same or different, are as defined and exemplified in the description of R² above.

The alkynyl groups represented by R⁹, which may be the same or different, typically have from 2 to about 10 carbon atoms, alternatively from 2 to 6 carbon atoms, and are exemplified by, but not limited to, ethynyl, propynyl, butynyl, hexynyl, and octynyl.

The silicone resin (A′″) typically has a number-average molecular weight (Mₙ) of at least 300, alternatively from 500 to 10,000, alternatively 1,000 to 3,000, where the molecular weight is determined by gel permeation chromatography employing a refractive index detector and silicone resin (MQ) standards.

The silicone resin (A′″) can contain less than 10% (w/w), alternatively less than 5% (w/w), alternatively less than 2% (w/w), of silicon-bonded hydroxy groups, as determined by ²⁹Si NMR.

Specific examples of silicone resins (A′″) that are suitable for purposes of the present invention include, but are not limited to, silicone resins having the following formulae:

(Vi₂MeSiO_{1/2})_{0.25}(PhSiO_{3/2})_{0.75},

(ViMe₂SiO_{1/2})_{0.25}(PhSiO_{3/2})_{0.75},

(ViMe₂SiO_{1/2})_{0.25}(MeSiO_{3/2})_{0.25}(PhSiO_{3/2})_{0.50},

(ViMe₂SiO_{1/2})_{0.15}(PhSiO_{3/2})_{0.75}(SiO_{4/2})_{0.1},

and

(Vi₂MeSiO_{1/2})_{0.15}(ViMe₂SiO_{1/2})_{0.1}(PhSiO_{3/2})₀₃₇₅,

wherein Me is methyl, Vi is vinyl, Ph is phenyl, and the numerical subscripts outside the parenthesis denote mole fractions. The sequence of units in the preceding formulae is not to be viewed in any way as limiting to the scope of the invention.

The free radical-cured silicone composition of the present method can comprise additional ingredients including, but are not limited to, silicone rubbers; unsaturated compounds; free radical initiators; organic solvents; UV stabilizers; sensitizers; dyes; flame retardants; antioxidants; fillers, such as reinforcing fillers, extending fillers, and conductive fillers; and adhesion promoters.

The free radical-cured silicone composition can further comprise the reaction product of an unsaturated compound selected from (i) at least one organosilicon compound having at least one silicon-bonded alkenyl group per molecule, (ii) at least one organic compound having at least one aliphatic carbon-carbon double bond per molecule, and (iii) mixtures comprising (i) and (ii), wherein the unsaturated compound has a molecular weight less than 500. Alternatively, the unsaturated compound has a molecular weight less than 400 or less than 300. Also, the unsaturated compound can have a linear, branched, or cyclic structure.

The organosilicon compound (I) can be an organosilane or an organosiloxane. The organosilane can be a monosilane, disilane, trisilane, or polysilane. Similarly, the organosiloxane can be a disiloxane, trisiloxane, or polysiloxane. Cyclosilanes and cyclosiloxanes typically have from 3 to 12 silicon atoms, alternatively from 3 to 10 silicon atoms, alternatively from 3 to 4 silicon atoms. In acyclic polysilanes and polysiloxanes, the silicon-bonded alkenyl group(s) can be located at terminal, pendant, or at both terminal and pendant positions.

Specific examples of organosilanes include, but are not limited to, silanes having the following formulae:

Vi₄Si,

PhSiVi₃,

MeSiVi₃,

PhMeSiVi₂,

Ph₂SiVi₂,

and

PhSi(CH₂CH═CH₂)₃,

wherein Me is methyl, Ph is phenyl, and Vi is vinyl.

Specific examples of organosiloxanes include, but are not limited to, siloxanes having the following formulae:

PhSi(OSiMe₂Vi)₃,

Si(OSiMe₂Vi)₄,

MeSi(OSiMe₂Vi)₃,

and

Ph₂Si(OSiMe₂Vi)₂,

wherein Me is methyl, Vi is vinyl, and Ph is phenyl.

The organic compound can be any organic compound containing at least one aliphatic carbon-carbon double bond per molecule, provided the compound does not prevent the silicone resin (A′″) from curing to form a silicone resin film. The organic compound can be an alkene, a diene, a triene, or a polyene. Further, in acyclic organic compounds, the carbon-carbon double bond(s) can be located at terminal, pendant, or at both terminal and pendant positions.

The organic compound can contain one or more functional groups other than the aliphatic carbon-carbon double bond. Examples of suitable functional groups include, but are not limited to, —O—, >C═O, —CHO, —CO₂—, —C≡N, —NO₂, >C═C<, —C═C—, —F, —Cl, —Br, and —I. The suitability of a particular unsaturated organic compound for use in the free-radical cured silicone composition of the present invention can be readily determined by routine experimentation.

The organic compound can have a liquid or solid state at room temperature. Also, the organic compound can be soluble, partially soluble, or insoluble in the free-radical cured silicone composition prior to curing. The normal boiling point of the organic compound, which depends on the molecular weight, structure, and number and nature of functional groups in the compound, can vary over a wide range. Preferably, the organic compound has a normal boiling point greater than the cure temperature of the composition. Otherwise, appreciable amounts of the organic compound may be removed by volatilization during cure.

Examples of organic compounds containing aliphatic carbon-carbon double bonds include, but are not limited to, 1,4-divinylbenzene, 1,3-hexadienylbenzene, and 1,2-diethenylcyclobutane.

The unsaturated compound can be a single unsaturated compound or a mixture comprising two or more different unsaturated compounds, each as described above. For example, the unsaturated compound can be a single organosilane, a mixture of two different organosilanes, a single organosiloxane, a mixture of two different organosiloxanes, a mixture of an organosilane and an organosiloxane, a single organic compound, a mixture of two different organic compounds, a mixture of an organosilane and an organic compound, or a mixture of an organosiloxane and an organic compound.

The concentration of the unsaturated compound is typically from 0 to 70% (w/w), alternatively from 10 to 50% (w/w), alternatively from 20 to 40% (w/w), based on the total weight of the free radical-cured silicone composition prior to curing.

Methods of preparing organosilanes and organosiloxanes containing silicon-bonded alkenyl groups, and organic compounds containing aliphatic carbon-carbon double bonds are well known in the art; many of these compounds are commercially available.

The free radical initiator is typically a free radical photoinitiator or an organic peroxide. Further, the free radical photoinitiator can be any free radical photoinitiator capable of initiating cure (cross-linking) of the silicone resin upon exposure to radiation having a wavelength of from 200 to 800 nm.

Examples of free radical photoinitiators include, but are not limited to, benzophenone; 4,4′-bis(dimethylamino)benzophenone; halogenated benzophenones; acetophenone; α-hydroxyacetophenone; chloro acetophenones, such as dichloroacetophenones and trichloroacetophenones; dialkoxyacetophenones, such as 2,2-diethoxyacetophenone; α-hydroxyalkylphenones, such as 2-hydroxy-2-methyl-1-phenyl-1-propanone and 1-hydroxycyclohexyl phenyl ketone; α-aminoalkylphenones, such as 2-methyl-4′-(methylthio)-2-morpholiniopropiophenone; benzoin; benzoin ethers, such as benzoin methyl ether, benzoin ethyl ether, and benzoin isobutyl ether; benzil ketals, such as 2,2-dimethoxy-2-phenylacetophenone; acylphosphinoxides, such as diphenyl(2,4,6-trimethylbenzoyl)phosphine oxide; xanthone derivatives; thioxanthone derivatives; fluorenone derivatives; methyl phenyl glyoxylate; acetonaphthone; anthraquinone derivatives; sulfonyl chlorides of aromatic compounds; and O-acyl α-oximinoketones, such as 1-phenyl-1,2-propanedione-2-(O-ethoxycarbonyl)oxime.

The free radical photoinitiator can also be a polysilane, such as the phenylmethylpolysilanes defined by West in U.S. Pat. No. 4,260,780, the disclosure of which as it relates to the phenylmethylpolysilanes is hereby incorporated by reference; the aminated methylpolysilanes defined by Baney et al. in U.S. Pat. No. 4,314,956, the disclosure of which is hereby incorporated by reference as it relates to aminated methylpolysilanes; the methylpolysilanes of Peterson et al. in U.S. Pat. No. 4,276,424, the disclosure of which is hereby incorporated by reference as it relates to methylpolysilanes; and the polysilastyrene defined by West et al. in U.S. Pat. No. 4,324,901, the disclosure of which is hereby incorporated by reference as it relates to polysilastyrene.

The free radical photoinitiator can be a single free radical photoinitiator or a mixture comprising two or more different free radical photoinitiators. The concentration of the free radical photoinitiator is typically from 0.1 to 6% (w/w), alternatively from 1 to 3% (w/w), based on the weight of the silicone resin (A′″).

The free radical initiator can also be an organic peroxide. Examples of organic peroxides include, diaroyl peroxides such as dibenzoyl peroxide, di-p-chlorobenzoyl peroxide, and bis-2,4-dichlorobenzoyl peroxide; dialkyl peroxides such as di-t-butyl peroxide and 2,5-dimethyl-2,5-di-(t-butylperoxy)hexane; diaralkyl peroxides such as dicumyl peroxide; alkyl aralkyl peroxides such as t-butyl cumyl peroxide and 1,4-bis(t-butylperoxyisopropyl)benzene; and alkyl aroyl peroxides such as t-butyl perbenzoate, t-butyl peracetate, and t-butyl peroctoate.

The organic peroxide can be a single peroxide or a mixture comprising two or more different organic peroxides. The concentration of the organic peroxide is typically from 0.1 to 5% (w/w), alternatively from 0.2 to 2% (w/w), based on the weight of the silicone resin (A′″).

The free radical-cured silicone composition can further be formed in the presence of at least one organic solvent. The organic solvent can be any aprotic or dipolar aprotic organic solvent that does not react with the silicone resin (A′″) or additional ingredient(s) and is miscible with the silicone resin (A′″). Examples of organic solvents include, but are not limited to, saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; and halogenated aromatic hydrocarbons such as bromobenzene and chlorobenzene. The organic solvent can be a single organic solvent or a mixture comprising two or more different organic solvents, each as described above.

The concentration of the organic solvent is typically from 0 to 99% (w/w), alternatively from 30 to 80% (w/w), alternatively from 45 to 60% (w/w), based on the total weight of the free radical-cured silicone composition prior to curing.

When the free-radical cured silicone composition described above is formed from one or more additional ingredients, for example, a free radical initiator, the free-radical cured silicone composition may be formed from a one-part composition comprising the silicone resin and optional ingredient(s) in a single part, or a multi-part composition comprising the components in two or more parts.

In addition to the silicone compositions set forth above, other cured silicone compositions are also suitable for purposes of the present invention. For example, suitable silicone compositions, for purposes of the present invention, are disclosed in PCT Application No. JP2006/315901, the disclosures of which, as they relate to silicone compositions, are hereby incorporated by reference. Further, polysilsesquioxanes may also be suitable for purposes of the present invention.

The fiber reinforcement can be any reinforcement comprising fibers. The fiber reinforcement typically has a Young's modulus at 25° C. of at least 3 GPa. For example, the reinforcement typically has a Young's modulus at 25° C. of from 3 to 1,000 GPa, alternatively from 3 to 200 GPa, alternatively from 10 to 100 GPa. Moreover, the reinforcement typically has a tensile strength at 25° C. of at least 50 MPa. For example, the reinforcement typically has a tensile strength at 25° C. of from 50 to 10,000 MPa, alternatively from 50 to 1,000 MPa, alternatively from 50 to 500 MPa.

The fiber reinforcement can be a woven fabric, e.g., a cloth; a nonwoven fabric, e.g., a mat or roving; or loose (individual) fibers. The fibers in the reinforcement are typically cylindrical in shape and have a diameter of from 1 to 100 μm, alternatively from 1 to 20 μm, alternatively form 1 to 10 μm. Loose fibers are typically continuous, meaning the fibers extend throughout the reinforced silicone film in a generally unbroken manner.

The fiber reinforcement is typically heat-treated prior to use to remove organic contaminants. For example, the fiber reinforcement is typically heated in air at an elevated temperature, for example, 575° C., for a suitable period of time, for example 2 hours.

Specific examples of fiber reinforcements that are suitable for purposes of the present invention include, but are not limited to, reinforcements comprising glass fibers; quartz fibers; graphite fibers; nylon fibers; polyester fibers; aramid fibers, such as Kevlar® and Nomex®; polyethylene fibers; polypropylene fibers; silicon carbide fibers; alumina fibers; silicon oxycarbide fibers; metal wires such as steel wires; and combinations thereof.

As set forth above, the fiber reinforcement is typically impregnated with the silicone composition. The fiber reinforcement may be impregnated with the silicone composition using a variety of methods. For example, the silicone composition, as described above, may be applied to a release liner to form a silicone film. The silicone composition can be applied to the release liner using conventional coating techniques, such as spin coating, dipping, spraying, brushing, or screen-printing. The silicone composition is applied in an amount sufficient to impregnate the fiber reinforcement. The release liner can be any rigid or flexible material having a surface from which the reinforced silicone resin film can be removed without damage by delamination after the silicone resin is cured. Examples of release liners include, but are not limited to, nylon, polyethyleneterephthalate, and polyimide.

The fiber reinforcement is then embedded in the silicone film, thereby forming an embedded fiber reinforcement. The fiber reinforcement can be embedded in the silicone film by simply placing the reinforcement on the silicone film and allowing the silicone composition to impregnate the reinforcement. However, it is to be appreciated that the fiber reinforcement may be first deposited on the release liner, followed by the application of the silicone composition onto the fiber reinforcement. In another embodiment, when the fiber reinforcement is woven or nonwoven fabric, the reinforcement can be impregnated with the silicone composition by passing it through the silicone composition without the used of the release liner. The fabric is typically passed through the silicone composition at a rate of from 1 to 1,000 cm/s at room temperature (˜23±2° C.).

The embedded fiber reinforcement is then optionally degassed. The embedded fiber reinforcement can be degassed by subjecting it to a vacuum at a temperature of from room temperature (˜23±2° C.) to 60° C., for a period of time sufficient to remove entrapped air in the embedded reinforcement. For example, the embedded fiber reinforcement can typically be degassed by subjecting it to a pressure of from 1,000 to 20,000 Pa for 5 to 60 min. at room temperature.

After degassing, additional silicone composition is applied to the embedded fiber reinforcement to form an impregnated fiber reinforcement. The silicone composition can be applied to the degassed embedded fiber reinforcement using conventional methods, as described above. Additional cycles of degassing and application of silicone composition may also occur.

The impregnated fiber reinforcement may also be compressed to remove excess silicone composition and/or entrapped air, and to reduce the thickness of the impregnated fiber reinforcement. The impregnated fiber reinforcement can be compressed using conventional equipment such as a stainless steel roller, hydraulic press, rubber roller, or laminating roll set. The impregnated fiber reinforcement is typically compressed at a pressure of from 1,000 Pa to 10 MPa and at a temperature of from room temperature (˜23±2° C.) to 50° C.

The impregnated fiber reinforcement is heated at a temperature sufficient to cure the silicone composition and form the reinforced silicone layer 14. The impregnated fiber reinforcement can be heated at atmospheric, sub-atmospheric, or supra-atmospheric pressure. The impregnated fiber reinforcement is typically heated at a temperature of from room temperature (˜23±2° C.) to 250° C., alternatively from room temperature to 200° C., alternatively from room temperature to 150° C., at atmospheric pressure. The impregnated fiber reinforcement is heated for a length of time sufficient to cure (cross-link) the silicone composition. For example, the impregnated fiber reinforcement is typically heated at a temperature of from 150 to 200° C. for a time of from 0.1 to 3 hours.

Alternatively, the impregnated fiber reinforcement can be heated in a vacuum at a temperature of from 100 to 200° C. and a pressure of from 1,000 to 20,000 Pa for a time of from 0.5 to 3 hours to form the reinforced silicone film. The impregnated fiber reinforcement can be heated in the vacuum using a conventional vacuum bagging process. In a typical process, a bleeder (e.g., polyester) is applied over the impregnated fiber reinforcement, a breather (e.g., nylon, polyester) is applied over the bleeder, a vacuum bagging film (e.g., nylon) equipped with a vacuum nozzle is applied over the breather, the assembly is sealed with tape, a vacuum (e.g., 1,000 Pa) is applied to the sealed assembly, and the evacuated bag is heated as described above.

The thickness of the reinforced silicone layer 14 is dependent upon the intended application for the composite article 10. Typically, the reinforced silicone layer 14 has a thickness of at least 1 mil, more typically from 2 to 100 mils, most typically about 5 mils.

The reinforced silicone layer 14 is disposed adjacent the first window layer 12. More specifically, the reinforced silicone layer 14 is adhered to the first window layer 12. In one embodiment, as shown in FIG. 1, the reinforced silicone layer 14 may be formed directly upon the first window layer 12. In this embodiment, the cured silicone composition includes at least one functional group prior to curing for adhering the cured silicone composition, and the reinforced silicone layer 14, to the first window layer 12. The at least one functional group may be selected from the group of, but is not limited to silanol groups, alkoxy groups, epoxy groups, silicon hydride groups, acetoxy groups, and combinations thereof. To form the reinforced silicone layer 14 directly upon the first window layer 12, the impregnated fiber reinforcement is formed as described above. The impregnated fiber reinforcement is then placed onto the first window layer 12 prior to completely curing the impregnated fiber reinforcement. Once the impregnated fiber reinforcement is disposed on the first window layer 12, the impregnated fiber reinforcement is heated to cure the silicone composition and form the reinforced silicone layer 14 and to adhere the reinforced silicone layer 14 onto the first window layer 12. When the reinforced silicone layer 14 is formed directly upon the first window layer 12, it is important to ensure that the vitreous material used to form the first window layer 12 is capable of withstanding the temperatures used to cure the silicone composition without breaking down or deforming. This is particularly applicable when the vitreous material comprises the carbon-based polymer.

In another embodiment, as shown in FIG. 3, the composite article 210 further includes an adhesive layer 20 disposed between the reinforced silicone layer 14 and the first window layer 12. More specifically, the reinforced silicone layer 14 is adhered to the first window layer 12 with the adhesive layer 20. The adhesive layer 20 typically comprises a silicone-based adhesive; however, it is to be appreciated that any adhesive suitable for adhering silicone to glass is suitable for purposes of the present invention. The silicone-based adhesive is particularly preferred since the silicone-based adhesive will provide further fire-resistance to the composite article that is not possible by using primarily carbon-based adhesives. The silicone-based adhesive typically includes at least one functional group for adhering the adhesive layer 20 to the reinforced silicone layer 14, and also for adhering the adhesive layer 20 to the first window layer 12. The at least one functional group may be selected from the group of, but is not limited to silanol groups, alkoxy groups, epoxy groups, silicon hydride groups, acetoxy groups, and combinations thereof. Such silicone-based adhesives are known in the art. The silicone-based adhesive may be a one part or a multi-part system.

Typically, as shown in FIG. 2, the composite article 110 further comprises a second window layer 16 formed from a second vitreous material and spaced from the first window layer 12, with the reinforced silicone layer 14 disposed between the first window layer 12 and the second window layer 16. As such, the reinforced silicone layer 14 is completely enclosed between the first window layer 12 and the second window layer 16 to protect the reinforced silicone layer 14 from scratching or other damage. The second window layer 16 is typically identical to the first window layer 12, and the second vitreous material is typically the same as the vitreous material of the first window layer 12; however, it is to be appreciated that in some applications, the first window layer 12 and the second window layer 16 may have different properties. For example, the first window layer 12 and the second window layer 16 may have different thicknesses, and may be formed from different vitreous materials.

In one embodiment, the composite article 210 of the present invention further comprises at least one additional reinforced silicone layer 14, and may comprise a plurality of additional reinforced silicone layers 14, in order to provide additional fire resistance to the composite article 210. The at least one additional reinforced silicone layer 14 may be the same or different from the reinforced silicone layer 14 in terms of thickness, type of fiber reinforcement, or type of cured silicone composition. As shown in FIG. 3, the at least one additional reinforced silicone layer 14 is disposed adjacent the reinforced silicone layer 14 and between the first window layer 12 and the second window layer 16. The adhesive layer 20, as described above, is typically disposed between the reinforced silicone layers 14; however, the reinforced silicone layer 14 and the at least one additional reinforced silicone layer 14 may be adhered through functional groups in the silicone composition that are present prior to curing, as described above.

In another embodiment, a third window layer 18 formed from a third vitreous material is disposed between the reinforced silicone layer 14 and the at least one additional reinforced silicone layer 14, with the layers 12, 14, 16, 18 adhered together as described above. The third window layer 18 may be the same or different from the first window layer 12 and/or the second window layer 16 in terms of thickness, and the third vitreous material may be the same or different from the vitreous material used to form the first window layer 12. The third window layer 18 is present in order to provide structural rigidity to the composite article 210. The number of window layers depends on the required structural rigidity, fire performance rating, and mechanical/thermal impact resistance requirements. In a most preferred embodiment, as shown in FIG. 3, at least two reinforced silicone layers 14 are disposed between each of the window layers in order to provide the composite article 10 with maximum fire resistance.

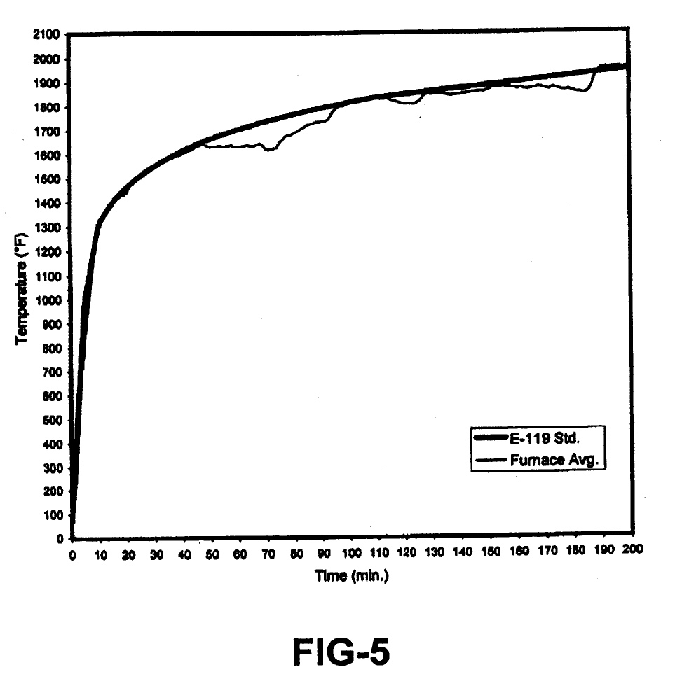

The composite articles 10 of the present invention have excellent fire resistance. More specifically, the composite articles 10 of the present invention typically have a fire rating of at least 30 minutes in accordance with at least one of ASTM E 119-05a without a hose stream impact, ASTM E 2010-01 with a hose stream impact, and ASTM E 2074-00. More typically, the composite articles 10 of the present invention have a fire rating of 90 minutes, and a breach does not form in the composite articles 10 for a period of greater than 180 minutes. The fire rating is an indication of the fire resistance of the composite article 10 and is a measurement of how long it takes to form a breach in the composite article 10 when exposed to heat provided by a furnace. To establish a fire rating in accordance with ASTM E 119-05a, the composite article 10 is placed in the furnace, and the furnace is heated to a temperature of about 1300° F. over a period of 10 minutes, and then continues to heat at a substantially constant rate up to a temperature of about 1950° F. over a period of 190 minutes. The rate of heating of the furnace is illustrated in FIG. 5. Although the breach will form in the composite article 10 during exposure to the heat, the composite article 10 typically melts, and the reinforced silicone layer 14 typically chars.

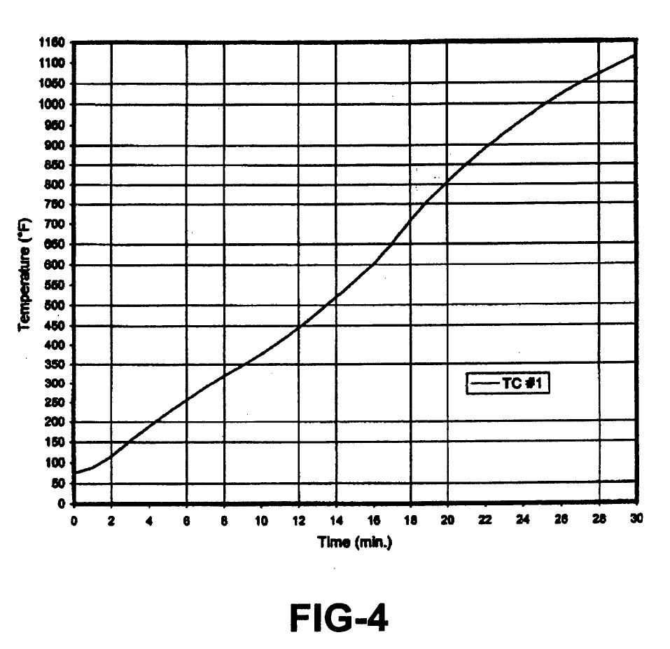

The composite articles 10 of the present invention also exhibit excellent heat insulating properties, as illustrated in FIG. 4. The excellent heat insulating properties are crucial to prevent the propagation of heat throughout a building during a fire, or to maintain heat within a contained space such as an oven.

Even once a breach forms in the composite article 10 of the present invention, the composite articles 10 may maintain substantial structural integrity due to the presence of the fiber reinforcement in the reinforced silicone layer 14. More specifically, the composite article 10 will typically not collapse from -its own weight regardless of the extent of charring due to the presence of the fiber reinforcement.

The following examples are meant to illustrate the invention and are not to be viewed in any way as limiting to the scope of the invention.

### Example 1

A composite article is formed by providing a series of windows layers, reinforced silicone layers, and adhesive layers. More specifically, window layers are formed from annealed float glass having a thickness of about 0.125 inch. The reinforced silicone layers include a cured silicone composition and fiber reinforcement. The cured silicone composition comprises a vinyldimethylsiloxy terminated phenylsilsesquioxane resin crosslinked by a SiH-functional crosslinker, and is commercially available from Dow Corning Corporation of Midland, Mich. The fiber reinforcement comprises a Style 106 glass fabric and has a thickness of about 1.5 mils. The adhesive layers comprise about 71 parts by weight of silicone-based adhesive and about 29 parts by weight of a polydimethylsiloxane (PDMS). The silicone-based adhesive is 6-3444 resin commercially available from Dow Corning Corporation, and the PDMS has a number average molecular weight such that the measured plasticity value is in between 55 to 65. The adhesive layers are provided on a release liner in order to permit handling of the adhesive layers.

To form the composite article, the release liner is removed from one of the adhesive layers and the adhesive layer is placed on top of one of the window layers. One of the reinforced silicone layers is then placed onto the adhesive layer. Additional adhesive layers and reinforced silicone layers are built to form a stack having three reinforced silicone layers. Another adhesive layer is placed on top of the third reinforced silicone layer. A second window layer is then placed on top of the stack. Three more reinforced silicone layers alternating with adhesive layers are then built on top of the second window layer, followed by a third window layer being placed on top of the stack to complete the composite article.

The composite article of Example 1 is fire rated in accordance with ASTM E 119-05a. More specifically, the composite article is fitted onto an opening of a furnace, with one side of the composite article exposed to the ambient atmosphere. The furnace is heated at a rate indicated in FIG. 5. A breach forms in the composite article after 195 minutes, and a temperature of a cold side, i.e., a side of the composite article that is exposed to the ambient atmosphere, is shown in FIG. 4 over time.

### Prophetic Example 2

A composite article may be fabricated through a similar procedure as described in Example 1 but using only two window layers as the outside layers. Three reinforced silicone resin layers and four adhesive layers may be disposed between to the two window layers.

### Prophetic Example 3

A composite article comprising two window layers and one reinforced silicone resin layer can be formed as follows. A partially cured glass fabric reinforced silicone layer is formed by coating a three mil thick layer of vinyldimethylsiloxy terminated phenylsilsesquioxane resin including the SiH-functional crosslinker and a catalyst on a silicone coated release paper, laying the Style 106 glass fabric into the liquid resin and curing the resin into a tacky semi-solid. Depending on the catalyst used, the curing conditions need to be adjusted to achieve this purpose. For example, if 10 ppm of platinum in the form of a complex with divinyltetramethyldisiloxane is used, room temperature standing of four to six hours may be enough. The partially cured resin film with glass fabric can then be placed on one of the window layers. The second window layer can be placed on top of the partially cured resin that includes the glass fabric to form the composite article. The composite article is then placed in a vacuum bag. Vacuum is applied and a curing procedure can be followed to complete curing of the resin. The following can be a suitable curing procedure: heating the composite article at a rate of 5° C./min. to a temperature of 100° C., maintaining the composite article at 100° C. for 1 hour, heating the composite article at a rate of 5° C./min to a temperature of 160° C., maintaining the composite article at 160° C. for 1 hour, and heating the composite article at a rate of 5° C./min to a temperature of 200° C., and maintaining the composite article at 200° C. for 1 hour.

Obviously, many modifications and variations of the present invention are possible in light of the above teachings, and the invention may be practiced otherwise than as specifically described within the scope of the appended claims.

1. A composite article comprising:
a first window layer formed from a vitreous material;
a reinforced silicone layer disposed adjacent said first window layer, said reinforced silicone layer comprising:
a cured silicone composition; and
a fiber reinforcement; and
a second window layer formed from a second vitreous material and spaced from said first window layer with said reinforced silicone layer disposed between said first window layer and said second window layer.

2. A composite article as set forth in claim 1 wherein said fiber reinforcement is further defined as at least one of a woven fabric, non-woven fabric, and loose fibers.

3. A composite article as set forth in claim 1 wherein said fiber reinforcement comprises fiber selected from the group of glass fibers, quartz fibers, graphite fibers, nylon fibers, polyester fibers, aramid fibers, polyethylene fibers, polypropylene fibers, silicon carbide fibers, alumina fibers, silicon oxycarbide fibers, metal wires, and combinations thereof.

4. A composite article as set forth in claim 1 wherein said fiber reinforcement is impregnated with said cured silicone composition.

5. A composite article as set forth in claim 1 wherein said cured silicone composition is further defined as a hydrosilylation-cured silicone composition.

6. A composite article as set forth in claim 5 wherein said hydrosilylation-cured silicone composition comprises the reaction product of:
(A) a silicone resin; and
(B) an organosilicon compound having an average of at least two silicon-bonded hydrogen atoms per molecule in an amount sufficient to cure said silicone resin;
in the presence of (C) a catalytic amount of a hydrosilylation catalyst.

7. A composite article as set forth in claim 6 wherein said silicone resin (A) has the formula:
(R¹R²₂SiO_{1/2})_{w}(R²₂SiO_{2/2})ₓ(R²SiO_{3/2})_{y}(SiO_{4/2})_{z}
wherein R¹ is a C₁ to C₁₀ hydrocarbyl group or a C₁ to C₁₀ halogen-substituted hydrocarbyl group, both free of aliphatic unsaturation, R² is R¹ or an alkenyl group, w is from 0 to 0.9, x is from 0 to 0.9, y is from 0 to 0.99, z is from 0 to 0.85, w+x+y+z=1, y+z/(w+x+y+z) is from 0.1 to 0.99, and w+x/(w+x+y+z) is from 0.01 to 0.9, provided said silicone resin (A) has an average of at least two silicon-bonded alkenyl groups per molecule.

8. A composite article as set forth in claim 1 wherein said cured silicone composition is further defined as a condensation-cured silicone composition.

9. A composite article as set forth in claim 8 wherein said condensation-cured silicone composition comprises the reaction product of:
(A″) a silicone resin having at least two of a silicon-bonded hydroxy group or a hydrolysable group; and
optionally, (B′) a cross-linking agent having silicon-bonded hydrolysable groups,
optionally, in the presence of (C′) a catalytic amount of a condensation catalyst.

10. A composite article as set forth in claim 9 wherein said silicone resin (A″) has the formula:
(R¹R⁶₂SiO_{1/2})_{w′}(R⁶₂SiO_{2/2})_{x′}(R⁶SiO_{3/2})_{y′}(SiO_{4/2})_{z′},
wherein R¹ is a C₁ to C₁₀ hydrocarbyl group or a C₁ to C₁₀ halogen-substituted hydrocarbyl group, both free of aliphatic unsaturation, R⁶ is R¹, —H, —OH, or a hydrolysable group, w′ is from 0 to 0.8, x′ is from 0 to 0.95, y′ is from 0 to 1, z′ is from 0 to 0.99, w′+x′+y′+z′=1, and said silicone resin (A″) has an average of at least two silicon-bonded hydrogen atoms, hydroxy groups, or hydrolysable groups per molecule.

11. A composite article as set forth in claim 8 wherein said condensation-cured silicone composition further includes an inorganic filler in particulate form.

12. A composite article as set forth in claim 1 wherein said cured silicone composition is further defined as a free radical-cured silicone composition.

13. A composite article as set forth in claim 12 wherein said free radical-cured silicone composition is formed from (A′″) a silicone resin having the formula:
(R¹R⁹₂SiO_{1/2})_{w″}(R⁹₂SiO_{2/2})_{x″}(R⁹SiO_{3/2})_{y″}(SiO_{4/2})_{z″}
wherein R¹ is a C₁ to C₁₀ hydrocarbyl group or a C₁ to C₁₀ halogen-substituted hydrocarbyl group, both free of aliphatic unsaturation; R⁹ is R¹, alkenyl, or alkynyl; w″ is from 0 to 0.99; x″ is from 0 to 0.99; y″ is from 0 to 0.99; z″ is from 0 to 0.85; and w″+x″+y″+z″=1.

14. A composite article as set forth in claim 1 wherein said vitreous material is selected from the group of polymethyl methacrylate, polycarbonate, and acrylic.

15. A composite article as set forth in claim 1 wherein said silicone composition includes at least one functional group prior to curing for adhering said cured silicone composition to said first window layer.

16. A composite article as set forth in claim 15 wherein said at least one functional group is selected from the group of silanol groups, alkoxy groups, epoxy groups, silicon hydride groups, acetoxy groups, and combinations thereof.

17. A composite article as set forth in claim 1 further comprising an adhesive layer disposed between said reinforced silicone layer and said first window layer.

18. A composite article as set forth in claim 17 wherein said adhesive layer comprises a silicone-based adhesive.

19. (canceled)

20. A composite article as set forth in claim 1 further comprising at least one additional reinforced silicone layer disposed adjacent said reinforced silicone layer.

21. A composite article as set forth in claim 20 further comprising an adhesive layer disposed between said reinforced silicone layers.

22. A composite article as set forth in claim 20 further comprising a third window layer formed from a third vitreous material and disposed between said reinforced silicone layer and said at least one additional reinforced silicone layer.

23. A composite article as set forth in claim 22 wherein at least two reinforced silicone layers are disposed between each of said window layers.

24. A composite article as set forth in claim 1 having a fire rating of at least 30 minutes in accordance with at least one of ASTM E 119-05a, ASTM E 2010-01, and ASTM E 2074-00.
